(19) United States
(12) Patent Application Publication
(10) Pub. No.: US 2011/0191129 A1
(43) Pub. Date: Aug. 4, 2011

(54) Random Number Generator Generating Random Numbers According to an Arbitrary Probability Density Function

(76) Inventor: Netzer MORIYA, Ramat Hasharon (IL)

(21) Appl. No.: 13/019,374

(22) Filed: Feb. 2, 2011

(30) Foreign Application Priority Data
Feb. 4, 2010 (IL) 203719

(51) Int. Cl. G06F 7/58; G06F 17/10; G06F 17/30; H04L 9/00; A63F 9/24; G06Q 10/00

(52) U.S. Cl. 705/7.11; 708/250; 708/205; 703/2; 707/769; 380/277; 463/16; 707/E17.014

(57) ABSTRACT

A method for generating a stream of random numbers which is representative of a probability distribution function, the method comprising receiving a set of K values xᵢ (i=1, . . . K), thereby to define a range within which all of said values fall, and information indicative of the relative probability of each value under said probability distribution function, for each individual value xᵢ (i=1, . . . K) generating a set of nᵢ numbers uniformly distributed over a vicinity of said individual value xᵢ, where nᵢ is determined, using said information, to reflect the relative probability of said individual value xᵢ, and where the vicinities of xᵢ, for all i=1 . . . K partition said range within which all of said values fall, and providing a stream of numbers by randomly selecting numbers from a set S comprising the union of said sets of nᵢ numbers, for i=1, . . . K.

### REFERENCE TO CO-PENDING APPLICATIONS

This application claims priority from Israeli application no. 203719 filed on Feb. 4, 2010 and entitled “Random Number Generator Generating Random Numbers According to an Arbitrary Probability Density Function”.

### FIELD OF THE INVENTION

The present invention relates generally to computerized generation of random numbers and more particularly to apparatus and methods which utilize computer-generated random numbers.

### BACKGROUND OF THE INVENTION

Conventional technology pertaining to certain embodiments of the present invention is described in the following publications inter alia:

| No. | PAT. NO. | Title |
|---|---|---|
| 1 | 7,550,858 | Random sequence generation using alpha particle emission |
| 2 | 7,530,036 | Random test generation using an optimization solver |
| 3 | 7,515,615 | Systems and methods for pseudo-random signal generation in a |
| | | multi-carrier communications system |
| 4 | 7,509,500 | Random number generation for encrypting cellular |
| | | communications |
| 5 | 7,496,617 | Tamper proof generation of true random numbers |
| 6 | 7,479,837 | Noise signal generation by mapping random words |
| 7 | 7,475,102 | Random number generation method based on multivariate non- |
| | | normal distribution, parameter estimation method thereof, and |
| | | application to simulation of financial field and semiconductor ion |
| | | implantation |
| 8 | 7,461,111 | Method of uniforming physical random number and physical |
| | | number generation device |
| 9 | 7,434,101 | Highly specialized scenarios in random test generation |
| 10 | 7,412,468 | Generation of cryptographically strong random numbers using |
| | | MISRS |
| 11 | 7,390,256 | Method, apparatus and article for random sequence generation |
| | | and playing card distribution |
| 12 | 7,389,316 | Method and apparatus for true random number generation |
| 13 | 7,360,184 | Method and apparatus for scenario search based random |
| | | generation of functional test suites |
| 14 | 7,349,935 | Random number generation apparatus |
| 15 | 7,330,328 | Random number generation using back electromotive force |
| | | (BEMF) values |
| 16 | 7,315,874 | Electronic circuit for random number generation |
| 17 | 7,308,467 | Method for on-demand generation of individual random numbers |
| | | of a sequence of random numbers of a 1/f noise |
| 18 | 7,257,224 | Cryptographical pseudo-random number generation apparatus and |
| | | program |
| 19 | 7,242,776 | Method and apparatus for the generation and distribution of |
| | | random bits |
| 20 | 7,237,166 | System and method for evaluating a multiprocessor system using |
| | | a random bus traffic generation technique |
| 21 | 7,235,009 | Gaming device having a bonus round with multiple random award |
| | | generation and multiple return/risk scenarios |
| 22 | 7,233,965 | Continuous random number generation method and apparatus |
| 23 | 7,197,523 | Efficient use of detectors for random number generation |
| 24 | 7,170,996 | Random number generation for encrypting cellular |
| | | communications |
| 25 | 7,167,882 | True random number generation |
| 26 | 7,167,426 | Data recording/reproducing method and apparatus including |
| | | random number generation and data sector scrambling |
| 27 | 7,133,818 | Method and apparatus for accelerated post-silicon testing and |
| | | random number generation |
| 28 | 7,124,155 | Latching electronic circuit for random number generation |
| 29 | 7,113,595 | Generation of a random number that is non-divisible by a set of |
| | | prime numbers |
| 30 | 7,096,242 | Random number generator and generation method |
| 31 | 7,089,274 | Method and an electrical device for efficient generation of multi- |
| | | rate pseudo random noise (PN) sequence |
| 32 | 7,054,379 | Data scrambler generation of pseudo-random bit sequence for |
| | | semi-stationary Q-mode signal |
| 33 | 7,047,262 | Entropy estimation and decimation for improving the randomness |
| | | of true random number generation |
| 34 | 7,046,803 | Random keystream generation apparatus and method for use in an |
| | | encryption system |
| 35 | 7,028,059 | Apparatus and method for random number generation |
| 36 | 7,020,283 | Random number generation apparatus and random number |
| | | generation method |
| 37 | 7,007,060 | Random bit stream generation by amplification of thermal noise |
| | | in a CMOS process |
| 38 | 7,007,050 | Method and apparatus for improved pseudo-random number |
| | | generation |
| 39 | 7,003,109 | Compact crypto-engine for random number and stream cipher |
| | | generation |
| 40 | 6,993,542 | Efficient random number generation for communication systems |
| 41 | 6,968,285 | Method and apparatus for scenario search based random |
| | | generation of functional test suites |
| 42 | 6,965,852 | Pseudo random test pattern generation using Markov chains |
| 43 | 6,948,074 | Method and system for distributed generation of unique random |
| | | numbers for digital tokens |
| 44 | 6,918,098 | Random code generation using genetic algorithms |
| 45 | 6,832,231 | Multiple width random number generation |
| 46 | 6,829,628 | Random number generation method and system |
| 47 | 6,813,625 | Method and device for self-clock controlled pseudo random noise |
| | | (PN) sequence generation |
| 48 | 6,776,711 | Gaming device having a bonus round with multiple random award |
| | | generation and multiple return/risk scenarios |
| 49 | 6,771,104 | Switching electronic circuit for random number generation |
| 50 | 6,763,364 | Random number generator and generation method |
| 51 | 6,714,955 | High speed random number generation |
| 52 | 6,678,707 | Generation of cryptographically strong random numbers using |
| | | MISRs |
| 53 | 6,677,791 | Clock generation circuit, control method of clock generation |
| | | circuit, clock reproducing circuit, semiconductor memory device, |
| | | and dynamic random access memory |
| 54 | 6,671,664 | Management of uncommitted register values during random |
| | | program generation |
| 55 | 6,598,133 | Successive template generation using minimal random access |
| | | memory bandwidth |
| 56 | 6,559,857 | Method and apparatus for pseudo-random noise generation based |
| | | on variation of intensity and coloration |
| 57 | 6,559,712 | Method and device for the generation of a random signal with |
| | | controlled histogram and spectrum |
| 58 | 6,553,531 | Method and apparatus for random stimulus generation |
| 59 | 6,513,144 | Method and apparatus for random stimulus generation |
| 60 | 6,499,127 | Method and apparatus for random stimulus generation |
| 61 | 6,449,745 | Method and apparatus for random stimulus generation |
| 62 | 6,437,619 | Clock generation circuit, control method of clock generation |
| | | circuit, clock reproducing circuit, semiconductor memory device, |
| | | and dynamic random access memory |
| 63 | 6,385,111 | Reference signal generation for magnetic random access memory |
| | | devices |
| 64 | 6,374,278 | Method and apparatus for the generation of statistically random |
| | | numbers |
| 65 | 6,369,727 | Analog-to-digital conversion method of random number |
| | | generation |
| 66 | 6,324,558 | Random number generator and generation method |
| 67 | 6,324,027 | Method and apparatus for correcting for random errors in timing |
| | | pattern generation |
| 68 | 6,317,376 | Reference signal generation for magnetic random access memory |
| | | devices |
| 69 | 6,314,534 | Generalized address generation for bit reversed random |
| | | interleaving |
| 70 | 6,279,116 | Synchronous dynamic random access memory devices that utilize |
| | | clock masking signals to control internal clock signal generation |
| 71 | 6,226,607 | Method and apparatus for eighth-rate random number generation |
| | | for speech coders |
| 72 | 6,223,337 | Random test generation for compiler optimization |
| 73 | 6,164,944 | Random error generation of tooth index to eliminate pump noise |
| 74 | 6,146,270 | Auxiliary game with random prize generation |
| 75 | 6,139,430 | Auxiliary game with random prize generation |
| 76 | 6,128,692 | Programming and verification address generation for random |
| | | access memory blocks in programmable logic array integrated |
| | | circuit devices |
| 77 | 6,110,218 | Generation of multiple simultaneous random test cycles for |
| | | hardware verification of multiple functions of a design under test |
| 78 | 6,078,450 | Method and apparatus for correcting for random errors in timing |
| | | pattern generation |
| 79 | 6,075,668 | Method and apparatus for correcting for random errors in timing |
| | | pattern generation |
| 80 | 6,061,819 | Generation of reproducible random initial states in RTL |
| | | simulators |
| 81 | 6,034,664 | Method and apparatus for pseudo-random noise generation based |
| | | on variation of intensity and coloration |
| 82 | 6,014,445 | Enciphering/deciphering apparatus and method incorporating |
| | | random variable and keystream generation |
| 83 | 5,943,248 | w-bit non-linear combiner for pseudo-random number generation |
| 84 | 5,897,662 | Pseudo-random address generation mechanism that reduces |
| | | address translation time |
| 85 | 5,886,932 | Composite mode substrate voltage generation circuit for dynamic |
| | | random access memory |
| 86 | 5,872,725 | Quasi-random number generation apparatus and method, and |
| | | multiple integration apparatus and method of function f |
| 87 | 5,841,680 | Random pulse generation |
| 88 | 5,822,432 | Method for human-assisted random key generation and |
| | | application for digital watermark system |
| 89 | 5,802,540 | Programming and verification address generation for random |
| | | access memory blocks in programmable logic array integrated |
| | | circuit devices |
| 90 | 5,779,545 | Central random number generation for gaming system |
| 91 | 5,743,800 | Auxiliary game with random prize generation |
| 92 | 5,692,122 | Generation of random conversation testcases |
| 93 | 5,594,741 | Method for control of random test vector generation |
| 94 | 5,570,307 | Digital randomizer for on-chip generation and storage of random |
| | | self-programming data block |
| 95 | 5,499,249 | Method and apparatus for test generation and fault simulation for |
| | | sequential circuits with embedded random access memories |
| | | (RAMs) |
| 96 | 5,434,806 | Apparatus and method for random number generation |
| 97 | 5,416,434 | Adaptive clock generation with pseudo random variation |
| 98 | 5,323,400 | Scan cell for weighted random pattern generation and method for |
| | | its operation |
| 99 | 5,321,641 | Pseudo random pattern generation circuit |
| 100 | 5,225,915 | Image processing with noise enhancing operators for moire |
| | | reduction and/or random dot generation |
| 101 | 5,214,423 | Random number generation using volatile RAM |
| 102 | 5,202,889 | Dynamic process for the generation of biased pseudo-random test |
| | | patterns for the functional verification of hardware designs |
| 103 | 5,148,663 | Arrangement for generation of fancy twists arranged and/or |
| | | formed at random on a yarn |
| 104 | 5,043,988 | Method and apparatus for high precision weighted random pattern |
| | | generation |
| 105 | 5,010,721 | Arrangement for the generation of a yarn having fancy twists |
| | | arranged and/or formed at random |
| 106 | 4,755,969 | Pseudo random sequence generation |
| 107 | 4,573,681 | Slot machine with random number generation |
| 108 | 4,509,137 | Language translator with random generation of test words during |
| | | learning mode |
| 109 | 4,499,551 | Rapid generation of discrete random variates from general |
| | | distributions |
| 110 | 4,493,046 | Apparatus for generation of binary pseudo-random numbers |

It is appreciated that Random Numbers need to be generated in state of the art cryptographic applications such as, “Challenge-Response-Protocols” (e.g. as described in U.S. Pat. Nos. 7,203,836, 6,161,180), “RSA prime factors” (e.g. as described in U.S. Pat. Nos. 7,313,701, 4,351,982), “Digital Signature Standard” (e.g. as described in U.S. Pat. Nos. 5,999,627, 5,299,263), “Hash Functions” (e.g. as described in U.S. Pat. Nos. 6,799,270, 6,490,352), “Schnorr Identification Scheme” (e.g. as described in U.S. Pat. Nos. 5,999,627) and “Diffie-Hellman Key Agreement Scheme” (e.g. as described in U.S. Pat. Nos. 7,600,118 , 5,999,627, 5,907,618).

Many applications of random number generators are known such as computerized simulations in meterological, military and other technological fields; cryptography; personnel selection such as for juror duty or military draft or samples for opinion polling; randomized experimental designs; and gambling.

For example, in the design of experiments, randomized designs such as completely randomized designs allow effects of one factor to be studied while neutralizing other nuisance variables. Randomization, which is typically computerized, may be used to avoid an undesirable, confounding experiment in which, say, 2 replications are always run for the first level, then 2 for the second level, and finally 2 for the third level.

Computer simulations are useful in design, forecasting, analysis and verification, in applications including but not limited to: analysis of air pollutant dispersion using atmospheric dispersion modeling, design of complex systems such as aircraft and logistics systems, design of noise barriers to affect roadway noise mitigation, flight simulators, weather forecasting, forecasting of prices on financial markets, construction and industrial applications which are a function of behavior of structures, such as buildings, machines and industrial parts under stress and environmental conditions, design of industrial processes, such as chemical processing plants, reservoir simulation for petroleum engineering modelling of a subsurface reservoir, Process Engineering Simulation, robot simulators for robot design and control, traffic engineering, modeling of car crashes to test safety mechanisms in vehicles; and development of medications.

The disclosures of all publications and patent documents mentioned in the specification, and of the publications and patent documents cited therein directly or indirectly, are hereby incorporated by reference.

### SUMMARY OF THE INVENTION

Given an arbitrary Distribution Function and a corresponding Probability Density Function (PDF), certain embodiments of the present invention are operative to generate a set of pseudo-random values that when histogramed result in a probability density function that is statistically indistinguishable from the original PDF.

Generation of pseudo-random numbers whose distributions are known in advance to obey a certain profile, is known, e.g. by use of Stochastic Transformations, where one distribution may be transformed to another if the transformation function is known and particularly if transformation function is differentiable and linear such that there is a closed form solution for the transformed distribution.

Certain embodiments of the present invention seek to generate random values based on an arbitrary sketch of a requested PDF.

Certain embodiments of the present invention seek to provide a random number generating system comprising input apparatus operative to receive a stream of user inputs defining a plurality of probability density functions including at least one non-differentiable probability density function, and apparatus for generating random numbers distributed according to a non-differentiable probability density function defined by the user input.

Certain embodiments of the present invention use a random number generation method including some or all of the following steps, suitably ordered e.g. as shown:

a. Receive y(x), a desired final distribution according to which random values are to be generated. Define Δx=xₙ₊₁−xₙ, and parameters L, representing the number of random values required by the application, and N, representing the total amount of random numbers to be generated.

b. Normalize the distribution y(x)

c. Compute the Dynamic Range of the distribution y(x) e.g. as described herein with reference to Formulae IV-XXVI and steps 140 and 240 of FIGS. 2 and 3 respectively.

d. factorize the distribution y(x) so that the minimal value is conditioned by a pre-defined value and an additional pre-defined value for the difference between the minimal and maximal values for the resulting PDF, each of which may be related to the Dynamic Range.

e. round the factorized distribution so that all numbers are natural (g(xₙ))

f. for each value of the rounded factorized distribution and the corresponding xₙ generate a, preferably uniform, pseudo-random set of g numbers in the range of

$$[ {x}_{n} - \frac{Δ x}{2} , {x}_{n} + \frac{Δ x}{2} ]$$

for the case where xᵢ₊₁−xᵢ=Δx for all is i≦n or otherwise

g. repeat the above so that the total numbers generated exceeds N.

h. randomly mix the indices of the distribution in (f) above

i. select the first L values from distribution (h) above

There is thus provided, in accordance with at least one embodiment of the present invention, a method for generating a stream of random numbers which is representative of a probability distribution function, the method comprising receiving a set of K values xᵢ (i=1, . . . K), thereby to define a range within which all of the values fall, and information indicative of the relative probability of each value under the probability distribution function; for each individual value xᵢ (i=1, . . . K) generating a set of nᵢ numbers uniformly distributed over a vicinity of the individual value xᵢ, where nᵢ is determined, using the information, to reflect the relative probability of the individual value xᵢ and where the vicinities of xᵢ for all i=1 . . . K partition the range within which all of the values fall; and providing a stream of numbers by randomly selecting numbers from a set S comprising the union of the sets of nᵢ numbers, for i=1, . . . K.

Further in accordance with at least one embodiment of the present invention, the information comprises a set of K probability values yᵢ wherein each yᵢ represents a relative probability of its corresponding xᵢ under the probability distribution function.

Still further in accordance with at least one embodiment of the present invention, the generating includes obtaining a set of all-positive probability values equalling the yᵢ values if all are non-negative.

Additionally in accordance with at least one embodiment of the present invention, if any of the probability values yᵢ are negative, the obtaining includes translating all of the probability values yᵢ to obtain the set of all-positive probability values by adding a value which is at least as large as the most negative probability value yᵢ, to all of the probability values yᵢ.

Still further in accordance with at least one embodiment of the present invention, the generating also includes normalizing the all-positive probability values thereby to generate normalized values y′ᵢ.

Additionally in accordance with at least one embodiment of the present invention, the normalized values y′ᵢ are computed by setting y′ᵢ=aᵢyᵢ where aᵢ satisfies: aᵢΣᵢyᵢ/Δx=1.

Further in accordance with at least one embodiment of the present invention, the generating comprises computing a dynamic dᵣ range of the normalized values y′ᵢ.

Still further in accordance with at least one embodiment of the present invention, the method also comprises finding the smallest normalized value y′min from among the normalized values y′ᵢ and finding a coefficient c which fulfills c y′_min>=dᵣ.

Additionally in accordance with at least one embodiment of the present invention, the method also comprises computing factorized normalized probability values by multiplying each normalized values y′ᵢ by coefficient c.

Further in accordance with at least one embodiment of the present invention, the method also comprises rounding the factorized normalized probability values by rounding to obtain a natural number.

Yet further in accordance with at least one embodiment of the present invention, the method also comprises, for each xᵢ and a corresponding one of the factorized normalized probability values, bᵢ, defining an interval around xᵢ and generating a sequence of bᵢ random numbers distributed uniformly within the interval, thereby to obtain a set B of Σᵢ (bᵢ) numbers.

Still further in accordance with at least one embodiment of the present invention, intervals defined around adjacent xᵢ values meet at an endpoint which is halfway between the adjacent xᵢ values.

Additionally in accordance with at least one embodiment of the present invention, the xᵢ values form an arithmetic sequence defining a difference Δx between adjacent members of the sequence and wherein the interval comprises (xᵢ−Δx/2, xᵢ+Δx/2).

Also provided, in accordance with at least one embodiment of the present invention, is a method for generating a computer simulation of a physical phenomenon, the method comprising computerized generation of a stream of random numbers; and using the random numbers to generate a computerized simulation of a phenomenon, wherein the computerized generation includes performing any of the methods described herein.

Still further in accordance with at least one embodiment of the present invention, the phenomenon comprises a meteorological process.

Also provided, in accordance with at least one embodiment of the present invention, is a method for providing randomality to a gambling system, the method comprising generating a stream of random numbers using any of the methods described herein and using the stream of random numbers to regulate at least one random aspect of a gambling system.

Yet further provided, in accordance with at least one embodiment of the present invention, is a random personnel selection method comprising providing a personnel database in which each individual persona is associated with a data record in the database which is indexed by a number, thereby to define a multiplicity of numbers; and using any of the methods described herein for computerized generation of random numbers taken from among the multiplicity of numbers.

Further in accordance with at least one embodiment of the present invention, the method also comprises using the random numbers for an at least partly computerized juror duty selection process.

Additionally in accordance with at least one embodiment of the present invention, the method also comprises using the random numbers for an at least partly computerized military draft process.

Further in accordance with at least one embodiment of the present invention, the random numbers are representative of the database and wherein the method also comprises using the random numbers for an at least partly computerized process for conducting a survey.

Also in accordance with at least one embodiment of the present invention, the method also comprises using the random numbers for an at least partly computerized process for spot-checking the persona.

Further in accordance with at least one embodiment of the present invention, the persona comprise financial entities and wherein the at least partly computerized process comprises a financial auditing process.

Also provided, in accordance with at least one embodiment of the present invention, is an operations research method comprising performing an operations research analysis using a stream of random numbers; and using any of the methods described herein to provide the stream of random numbers.

Still further in accordance with at least one embodiment of the present invention, the operations research analysis comprises a simulation of a manufacturing facility.

Additionally in accordance with at least one embodiment of the present invention, the operations research analysis comprises financial optimization including generating a future economic scenario.

Further in accordance with at least one embodiment of the present invention, the operations research analysis comprises algorithm testing including creating random inputs to test at least one algorithm.

Also provided, in accordance with at least one embodiment of the present invention, is apparatus for generating a stream of random numbers which is representative of a probability distribution function, the system comprising an input device receiving a set of K values xᵢ (i=1, . . . K), thereby to define a range within which all of the values fall, and information indicative of the relative probability of each value under the probability distribution function; a uniform distribution generator generating, for each individual value xᵢ (i=1, . . . K), a set of nᵢ numbers uniformly distributed over a vicinity of the individual value xᵢ, where nᵢ is determined, using the information, to reflect the relative probability of the individual value xᵢ, and where the vicinities of xᵢ for all i=1 . . . K partition the range within which all of the values fall; and a number stream generator providing a stream of numbers by randomly selecting numbers from a set S comprising the union of the sets of nᵢ numbers, for i=1, . . . K.

Also provided, in accordance with at least one embodiment of the present invention, is a method for providing an at least partly randomized experimental design for an experiment, the method comprising generating a stream of random numbers using any of the methods described herein; and using the stream of random numbers to design at least one random aspect of an experiment.

Additionally provided, in accordance with at least one embodiment of the present invention, is a cryptographic method comprising performing a cryptographic process using a stream of random numbers; and using any of the methods described herein to provide the stream of random numbers.

Further in accordance with at least one embodiment of the present invention, the cryptographic process includes selecting a key; and using the key to perform at least one cryptographic operation, wherein the key is selected using the stream of random numbers provided by using any of the methods described herein.

Also provided, in accordance with at least one embodiment of the present invention, is a system for generating a computer simulation of a physical phenomenon, the system comprising RNG apparatus for computerized generation of a stream of random numbers; and simulation apparatus using the random numbers to simulate a phenomenon, wherein the RNG apparatus includes any of the apparatus described herein.

Further in accordance with at least one embodiment of the present invention, the phenomenon comprises a meteorological process.

Still further in accordance with at least one embodiment of the present invention, the simulation apparatus comprises Monte-Carlo simulation apparatus.

Also provided, in accordance with at least one embodiment of the present invention, is cryptographic apparatus comprising a key selector operative to select a key using RNG apparatus; and a cryptographic functionality using the key to perform at least one cryptographic operation, wherein the RNG apparatus comprises any of the apparatus described herein.

Also provided is a computer program product, comprising a computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein may be performed by a conventional personal computer processor, workstation or other programmable device or computer or electronic computing device, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may whereever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

### BRIEF DESCRIPTION OF THE DRAWINGS

Certain embodiments of the present invention are illustrated in the following drawings:

FIG. 1 is a simplified flowchart illustration of a first random number generation method generating a stream of random numbers which is representative of a probability distribution function, the method being constructed and operative in accordance with certain embodiments of the present invention.

FIGS. 2A-2D, taken together, form a simplified flowchart illustration of a second random number generation method generating a stream of random numbers which is representative of a probability distribution function, the method being constructed and operative in accordance with certain embodiments of the present invention.

FIGS. 3A-3D, taken together, form a simplified flowchart illustration of a third random number generation method generating a stream of random numbers which is representative of a probability distribution function, the method being constructed and operative in accordance with certain embodiments of the present invention.

FIG. 4 is a graph of an example normalized Probability Density Function (PDF) f_{X}(x), useful in accordance with certain embodiments of the present invention.

FIGS. 5-6 are useful in understanding a military application, presented as an example, for which the methods shown and described herein are particularly useful.

FIGS. 7A-10 are useful in understanding a first numerical example of certain modes of operation of the method of FIGS. 3A-3D.

FIGS. 11A-13 are useful in understanding a second numerical example of certain modes of operation of the method of FIGS. 3A-3D.

FIGS. 14A-14F are simplified flowchart illustrations of various applications for the method of FIGS. 2A-3D.

### DETAILED DESCRIPTION OF CERTAIN EMBODIMENTS

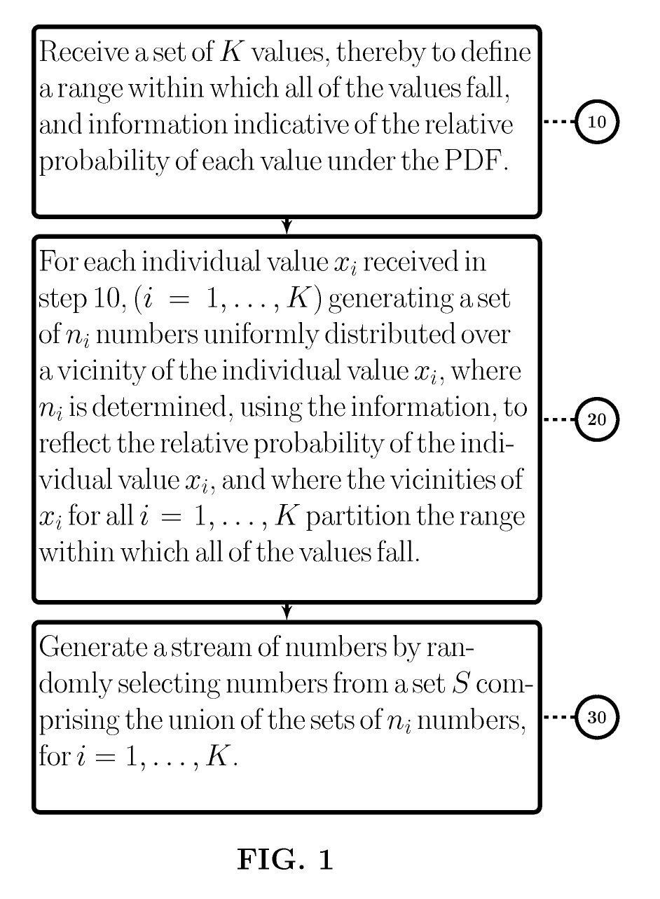

Reference is now made to FIG. 1 which is a simplified flowchart illustration of a first random number generation method generating a stream of random numbers which is representative of a probability distribution function, the method being constructed and operative in accordance with certain embodiments of the present invention. The method of FIG. 1 includes some or all of the following steps, suitably ordered e.g. as shown:
Step 10: receiving a set of N values, thereby to define a range within which all of the values fall, and information indicative of the relative probability of each value under the PDF;
Step 20: for each individual value xᵢ received in step 10 (i=1, . . . N) generating a set of nᵢ numbers uniformly distributed over a vicinity of the individual value xᵢ, where nᵢ is determined, using the information, to reflect the relative probability of the individual value xᵢ, and where the vicinities of xᵢ for all i=1 . . . N partition the range within which all of the values fall.

Step 30: generating a stream of numbers by randomly selecting numbers from a set S comprising the union of the sets of n, numbers, for i=1, . . . N.

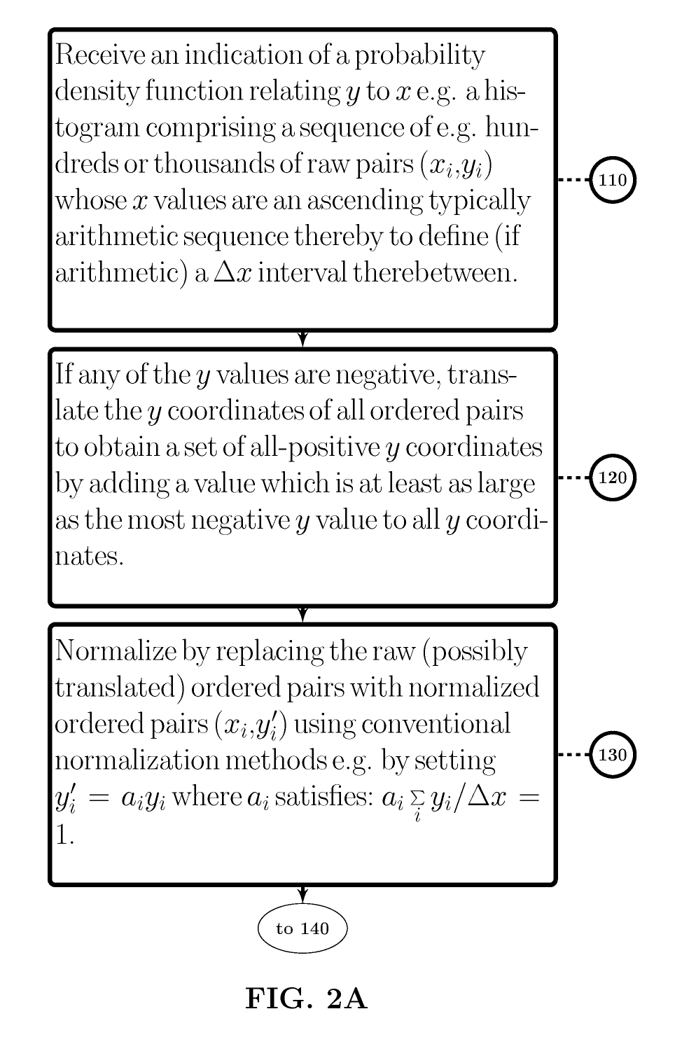

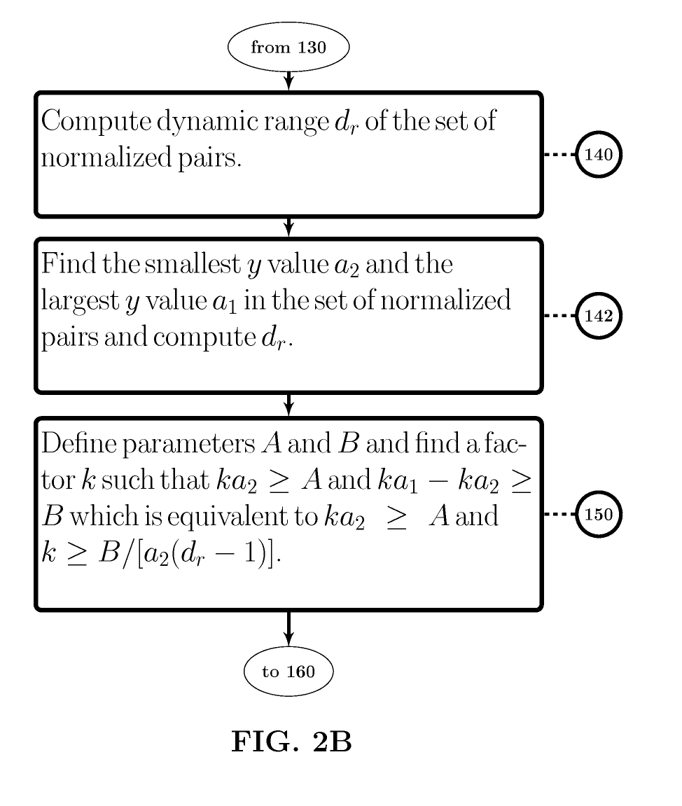

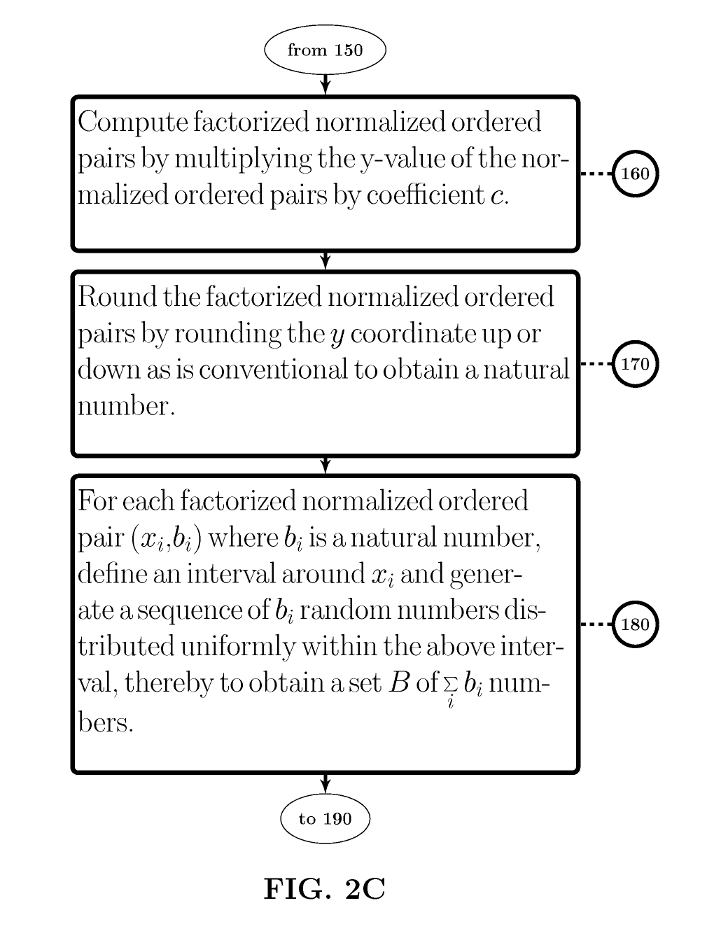

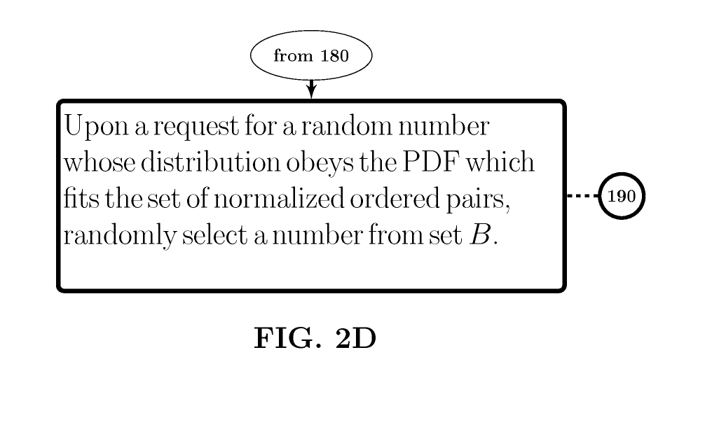

Reference is now made to FIGS. 2A-2D which taken together, form a simplified flowchart illustration of a second random number generation method generating a stream of random numbers which is representative of a probability distribution function, the method being constructed and operative in accordance with certain embodiments of the present invention. The method of FIGS. 2A-2D includes some or all of the following steps, suitably ordered e.g. as shown:

Step 110: Receive an indication of a probability density function relating y to x, e.g. a histogram comprising a sequence of e.g. hundreds or thousands of raw pairs (xᵢ, yᵢ) whose x values are an ascending typically arithmetic sequence thereby to define (if arithmetic) a Δx interval therebetween

Step 120: If any of the y values are negative, translate the y coordinates of all ordered pairs to obtain a set of all-positive y coordinates by adding a value which is at least as large as the most negative y value to all y coordinates

Step 130: Normalize by replacing the raw (possibly translated) ordered pairs with normalized ordered pairs (xᵢ, y′ᵢ) using conventional normalization methods e.g. given a set N pairs (xᵢ,yᵢ) ∀ i=1, . . . , N the normalization to a constant C, is obtained by:

$${\sum }_{i = 1}^{N} {y}_{i} [ \frac{{x}_{i + 1} - {x}_{i - 1}}{2} ] {a}_{i} = C$$

For the particular case where C=1 and xᵢ₊₁−xᵢ₋₁=2Δx and aᵢ=a ∀ i=1, . . . , N , it reduces to:

$$a {\sum }_{i = 1}^{N} {y}_{i} Δ x = 1$$

or:

$$a = \frac{1}{{\sum }_{i = 1}^{N} {y}_{i} Δ x}$$

Step 140: Define the dynamic range dᵣ as the ratio of the maximal and minimal values of the set of normalized pairs

Step 142: Find the smallest y value a₂ and the largest y value a₁ in the set of normalized pairs and compute dᵣ

Step 150: Define parameters A and B and find a factor k e.g. as described below, such that

$$\{ \begin{matrix}{ka}_{2} \geq A \\ {ka}_{1} - {ka}_{2} \geq B\end{matrix}$$

which is equivalent to

$$\{ \begin{matrix}{ka}_{2} \geq A \\ k \geq \frac{B}{{a}_{2 }} {( {d}_{r} - 1 )}^{- 1}\end{matrix}$$

Step 160: Compute factorized normalized ordered pairs by multiplying the y-value of the normalized ordered pairs by coefficient k

Step 170: Round the factorized normalized ordered pairs by rounding the y coordinate up or down as is conventional to obtain a natural number

More generally, steps 140-170 may be replaced by any method in which, for each individual pair received in step 110, the size (a natural number) of the set of random numbers that will be generated in the vicinity of the x coordinate of that pair is determined such that the size of the set of the individual pair reflects the probability of the individual pair's x value , relative to the probabilities of the x values of all the pairs received in step 110.

Step 180: For each factorized normalized ordered pair (xᵢ,bᵢ) where bᵢ a natural number, define an interval around xᵢ. and generate a sequence of bᵢ random numbers distributed uniformly within the above interval, thereby to obtain a set B of Σᵢ (bᵢ) numbers. The interval may, for example, be (xᵢ−Δx/2, xᵢ+Δx/2) if the raw values formed an arithmetic sequence. If true randomality is to be obtained, the endpoint of the intervals defined around adjacent xᵢ values, for instance x₆ and x₇, is midway between x₆ and x₇; if the demands of the application allow true randomality to be only approximated, the endpoint of the intervals defined around adjacent x, values need not be at the halfway point between them.

Step 190: Upon a request for a random number whose distribution obeys the PDF which fits the set of normalized ordered pairs, randomly select a number from set B.

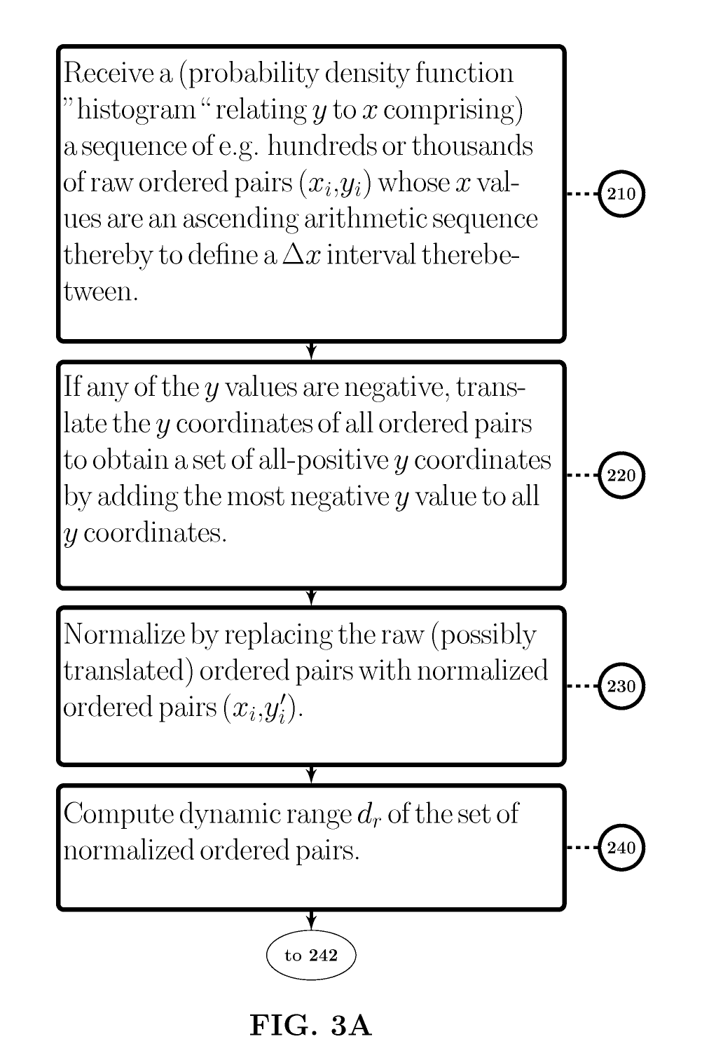

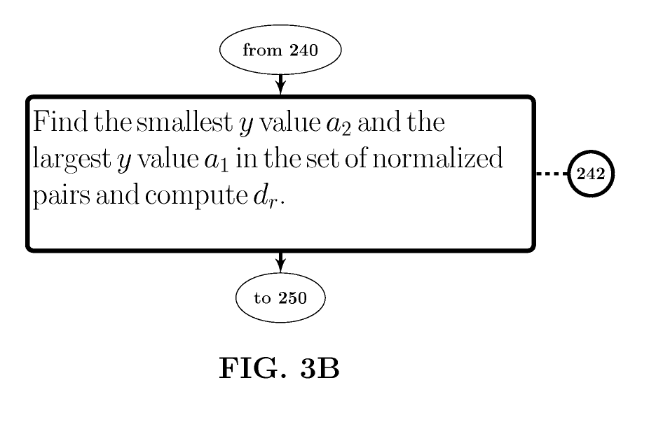

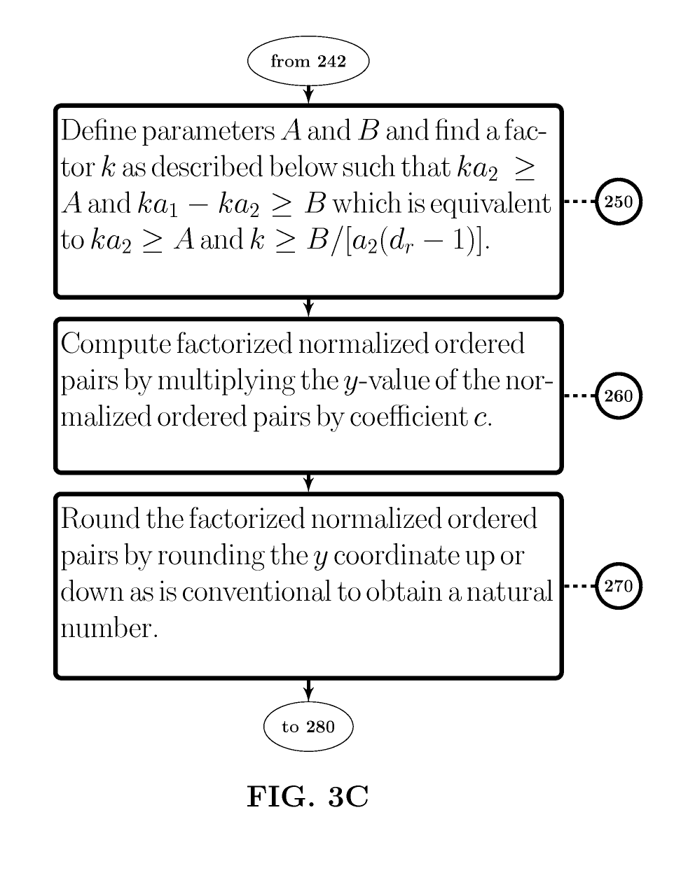

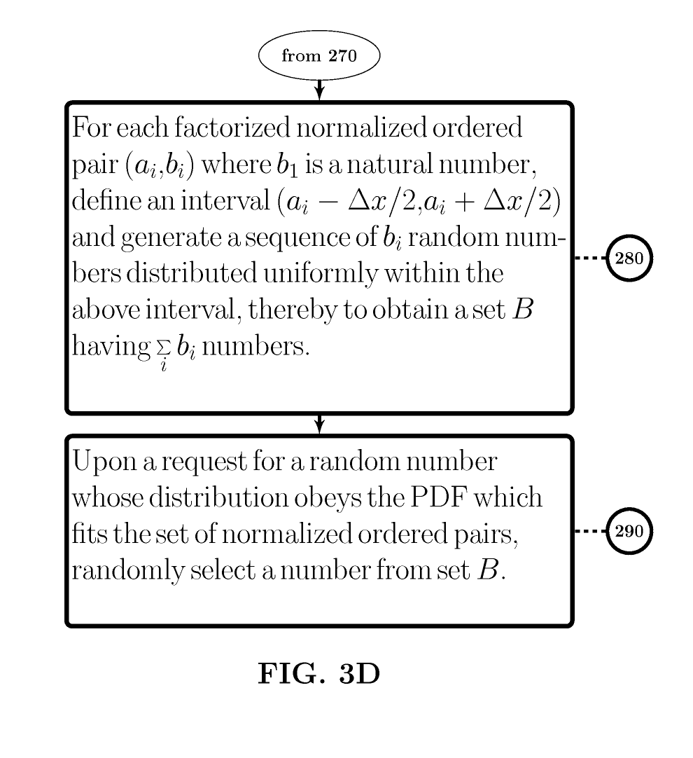

Reference is now made to FIGS. 3A-3D which taken together, form a simplified flowchart illustration of a third random number generation method generating a stream of random numbers which is representative of a probability distribution function, the method being constructed and operative in accordance with certain embodiments of the present invention. The method of FIGS. 3A-3D includes some or all of the following steps, suitably ordered e.g. as shown:

Step 210: Receive a (probability density function “histogram” relating y to x comprising) a sequence of e.g. hundreds or thousands of raw ordered pairs (xᵢ, yᵢ) whose x values are an ascending arithmetic sequence thereby to define a Δx interval therebetween.

Step 220: If any of the y values are negative, translate the y coordinates of all ordered pairs to obtain a set of all-positive y coordinates by adding the most negative y value to all y coordinates

Step 230: Normalize by replacing the raw (possibly translated) ordered pairs with normalized ordered pairs (xᵢ,y′ᵢ) using conventional normalization methods e.g. given a set N pairs (xᵢ,yᵢ) ∀ i=1, . . . , N the normalization to a constant C, is obtained by:

$${\sum }_{i = 1}^{N} {y}_{i} [ \frac{{x}_{i + 1} - {x}_{i - 1}}{2} ] {a}_{i} = C$$

For the particular case where C=1 and xᵢ₊₁−xᵢ₋₁=2Δx and aᵢ=a ∀ i=1, . . . , N, it reduces to:

$$a {\sum }_{i = 1}^{N} {y}_{i} Δ x = 1$$

or:

$$a = \frac{1}{{\sum }_{i = 1}^{N} {y}_{i} Δ x}$$

Step 240: Define the dynamic range dᵣ as the ratio of the maximal and minimal values of the set of normalized pairs

Step 242: Find the smallest y value a₂ and the largest y value a₁ in the set of normalized pairs and compute dᵣ

Step 250: Define parameters A and B and find a factor k e.g. as described below such that

$$\{ \begin{matrix}{ka}_{2} \geq A \\ {ka}_{1} - {ka}_{2} \geq B\end{matrix}$$

which is equivalent to

$$\{ \begin{matrix}k {a}_{2} \geq A \\ k \geq \frac{B}{{a}_{2}} {( {d}_{r} - 1 )}^{- 1}\end{matrix}$$

Step 260: Compute factorized normalized ordered pairs by multiplying the y-value of the normalized ordered pairs by coefficient k

Step 270: Round the factorized normalized ordered pairs by rounding the y coordinate up or down as is conventional to obtain a natural number

Step 280: For each factorized normalized ordered pair (xᵢ,bᵢ) where bᵢ is a natural number, define an interval e.g. (xᵢ−ΔAx/2, xᵢ+Δx/2) and generate a sequence of bᵢ random numbers distributed uniformly within the above interval, thereby to obtain a set B having Σᵢ (bᵢ) numbers

Step 290: Upon a request for a random number whose distribution obeys the PDF which fits the set of normalized ordered pairs, randomly select a number from set B.

Referring again to normalization steps 130 and 230 in FIGS. 2 and 3 respectively: In general, it is appreciated that any function f can be normalized such that its integral from minus infinity to infinity equals unity; once this is done, the normalized function can serve as a probability density function. It is appreciated that any conventional normalization technique may be employed to do this.

For example, given a set N pairs (xᵢ,yᵢ) ∀i=1, . . . , N the normalization to a constant C may be obtained by the following Formula I:

$${\sum }_{i = 1}^{N} {y}_{i} [ \frac{{x}_{i + 1} - {x}_{i - 1}}{2} ] {a}_{i} = C$$

For the case where C=1 and xᵢ₊₁−xᵢ₋₁=2Δx and aᵢ=a ∀ i=1, . . . , N, this reduces to the following Formula II:

$$a {\sum }_{i = 1}^{N} {y}_{i} Δ x = 1$$

### or (Formula III):

$$a = \frac{1}{{\sum }_{i = 1}^{N} {y}_{i} Δ x}$$

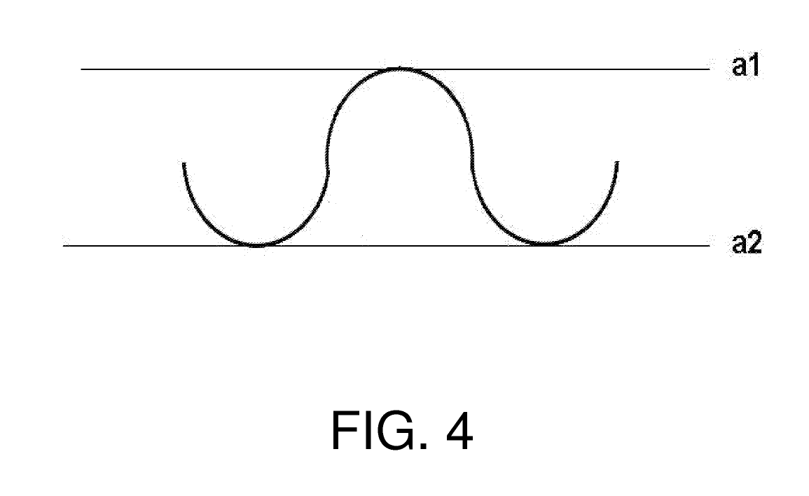

Referring again to dynamic range computation steps 140 and 240 in FIGS. 2 and 3 respectively, assume that a normalized Probability Density Function (PDF) fₓ(x) is given as shown in FIG. 4 and assume 0≦a₂≦a₁≦1. It is desired to find a parameter k so the following Formula IV holds:

$$\{ \begin{matrix}k {a}_{2} \geq A \\ k {a}_{1} - k {a}_{2} \geq B\end{matrix}$$

so, for instance, by multiplying fₓ(x) by k, its minimal value would be A (e.g., 10) and its maximal minus minimal values would equal B (e.g., 100). In other words, the following constraints (Formula V) are set on k:

$$\{ \begin{matrix}k \geq \frac{A}{{a}_{2}} \\ k \geq \frac{B}{( {a}_{1} - {a}_{2} )}\end{matrix}$$

In case a₂=0 the next non-zero minimum is to considered. Typically, a₁−a₂ should not vanish, as if true, the distribution is in fact constant and therefore uniform by definition.
a₁ and a₂ are both given. If (first case):

$$\frac{A}{{a}_{2}} < \frac{B}{( {a}_{1} - {a}_{2} )}$$

(Formula VI) then the following constraint (Formula VII) may be applied:

$$k \geq \frac{B}{( {a}_{1} - {a}_{2} )}$$

In this case, the condition

$$\frac{A}{{a}_{2}} < \frac{B}{( {a}_{1} - {a}_{2} )} \qquad ( Formula VIII )$$

implies that

$$A < \frac{{a}_{2} B}{( {a}_{1} - {a}_{2} )} , \qquad ( Formula IX )$$

that is, for an arbitrary decision on A and B, if

$$A < \frac{{a}_{2} B}{( {a}_{1} - {a}_{2} )} , \qquad ( Formula X )$$

the condition on k so as to fulfill Formula XI:

$$\{ \begin{matrix}k \geq \frac{A}{{a}_{2}} \\ k \geq \frac{B}{( {a}_{1} - {a}_{2} )} ,\end{matrix}$$

is reduced to

$$k \geq \frac{B}{( {a}_{1} - {a}_{2} )} . \qquad ( Formula XII )$$

If, however (second case):

$$\frac{A}{{a}_{2}} > \frac{B}{( {a}_{1} - {a}_{2} )} \qquad ( Formula XIII )$$

the following constraint may be applied (Formula XIV):

$$k \geq \frac{A}{{a}_{2}}$$

In this case, the condition

$$\frac{A}{{a}_{2}} > \frac{B}{( {a}_{1} - {a}_{2} )} \qquad ( Formula XV )$$

implies that

$$A > \frac{{a}_{2} B}{( {a}_{1} - {a}_{2} )} ; \qquad ( Formula XVI )$$

so for an arbitrary decision on A and B , if

$$A > \frac{{a}_{2} B}{( {a}_{1} - {a}_{2} )} , \qquad ( Formula XVII )$$

the condition on k so that

$$\{ \begin{matrix}k \geq \frac{A}{{a}_{2}} \\ k \geq \frac{B}{( {a}_{1} - {a}_{2} )}\end{matrix} \qquad ( Formula XVIII )$$

are fulfilled is reduced to

$$k \geq \frac{A}{{a}_{2}} . \qquad ( Formula XIX )$$

### Example 1

If a₁=0.8, a₂=0.7, A=10 and B=100, then the first case above may be applied since

$$\begin{matrix}\frac{A}{{a}_{2}} < \frac{B}{( {a}_{1} - {a}_{2} )} , as & ( Formula XX ) \\ \frac{10}{0.7} = \frac{100}{7} < \frac{100}{0.1} , & ( Formula XXI )\end{matrix}$$

and therefore:

$$\begin{matrix}k \geq \frac{B}{( {a}_{1} - {a}_{2} )} or & ( Formula XXII ) \\ k \geq \frac{100}{( 0.1 )} = 1000 & ( Formula XXIII )\end{matrix}$$

which leads to ka₁=800 and ka₂=700 which then satisfy the pre-requested conditions

$$\{ \begin{matrix}k {a}_{2} \geq A \\ k {a}_{1} - k {a}_{2} \geq B .\end{matrix} \qquad ( Formula XXIV ) .$$

### Example 2

If a₁=0.8, a₂=0.1, A=10 and B=1, then the second case above may be applied since

$$\begin{matrix}\frac{A}{{a}_{2}} > \frac{B}{( {a}_{1} - {a}_{2} )} , as & ( Formula XXV ) \\ \frac{10}{0.1} = 100 > \frac{1}{0.7} , & ( Formula XXVI )\end{matrix}$$

and therefore

$$\begin{matrix}k \geq \frac{A}{{a}_{2}} or & ( Formula XXVII ) \\ k \geq \frac{100}{( 0.1 )} = 100 & ( Formula XXVIII )\end{matrix}$$

which leads to ka₁=80 and ka₂=70 which then satisfy the pre-requested conditions

$$\{ \begin{matrix}k {a}_{2} \geq A \\ k {a}_{1} - k {a}_{2} \geq B .\end{matrix} \qquad ( Formula XXIX )$$

It is appreciated that since practically speaking, N is typically large, and may for example be in the order of magnitude of several or many millions for many simulation purposes, certain processes shown and described herein are only practical to perform using a computer, rather than by hand, such as but not limited to the following:

a. to generate a random number uniformly from the vicinity of xᵢ e.g. as in steps 180 and 280 described herein

b. to generate a stream of numbers by random selection from set B, e.g as in steps 190 and 290 described herein.

For example, if one million numbers need to be selected manually from a set of numbers, then even if selection is very fast, e.g. 5 numbers/sec, the process still requires 200,000 seconds (about one week), which is impractical.

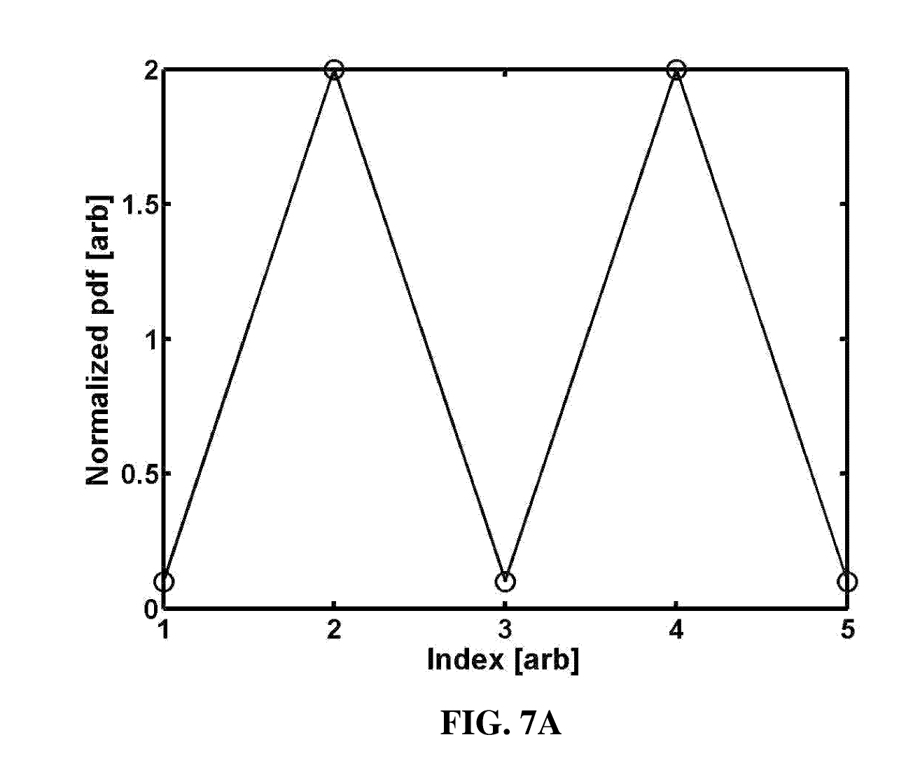

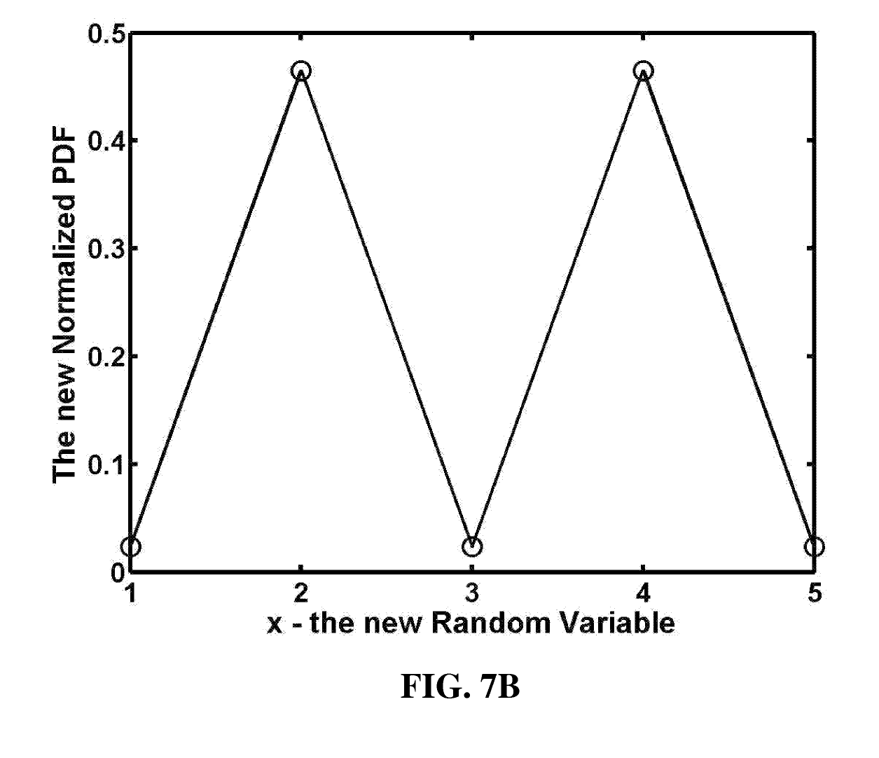

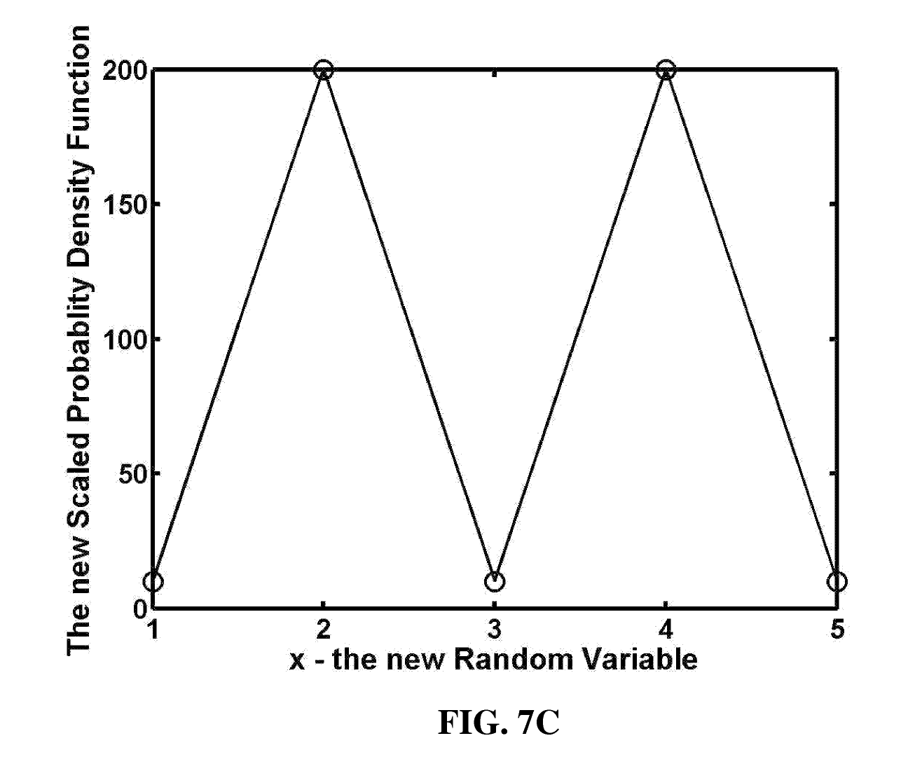

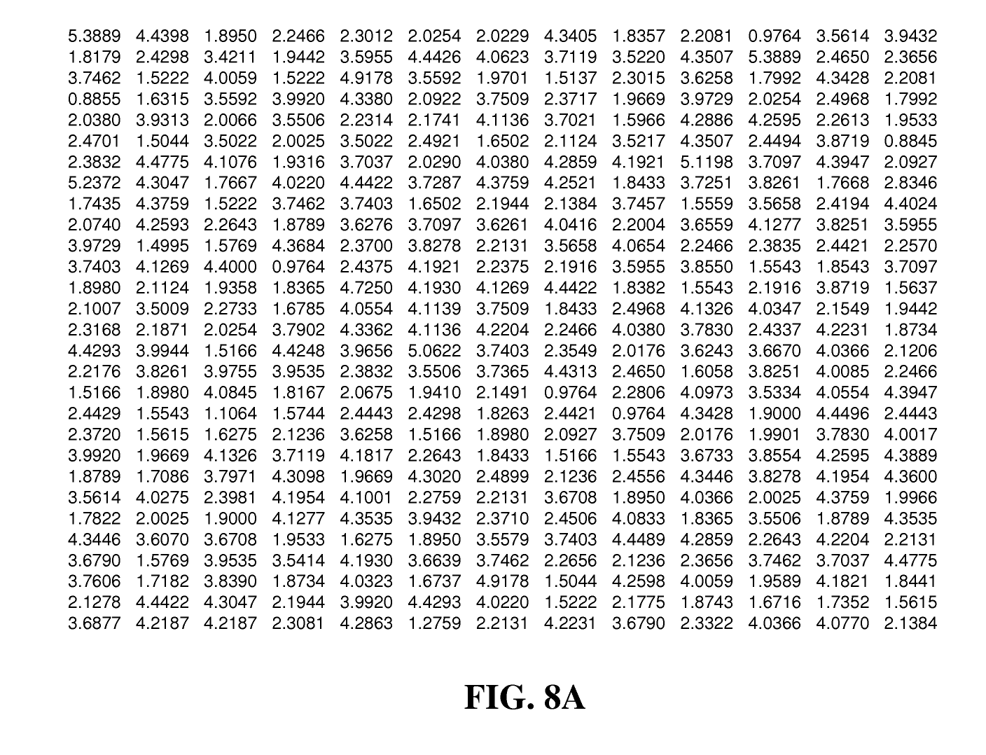

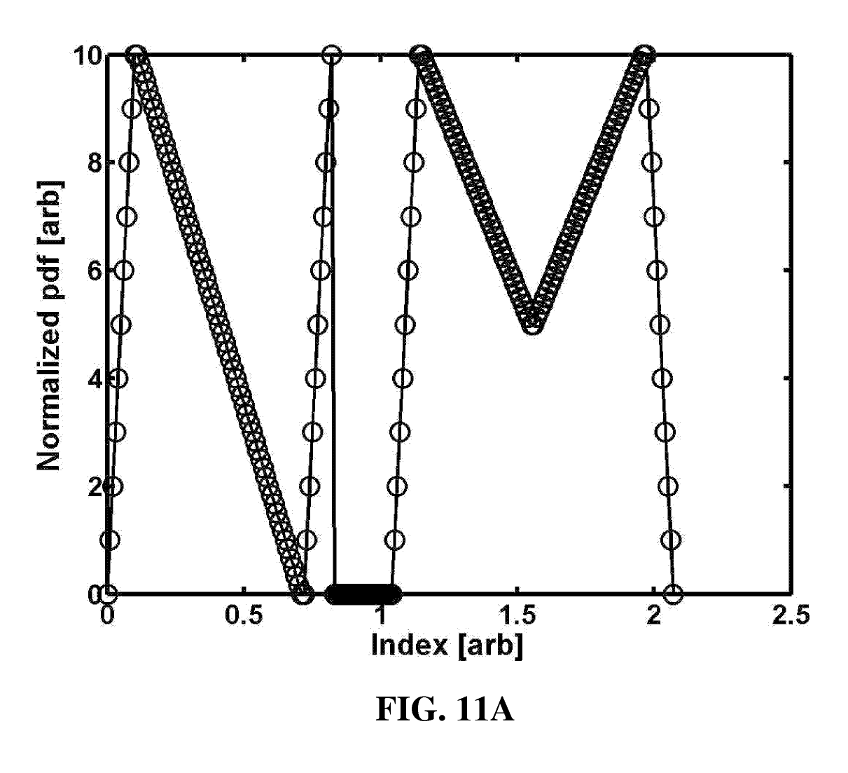

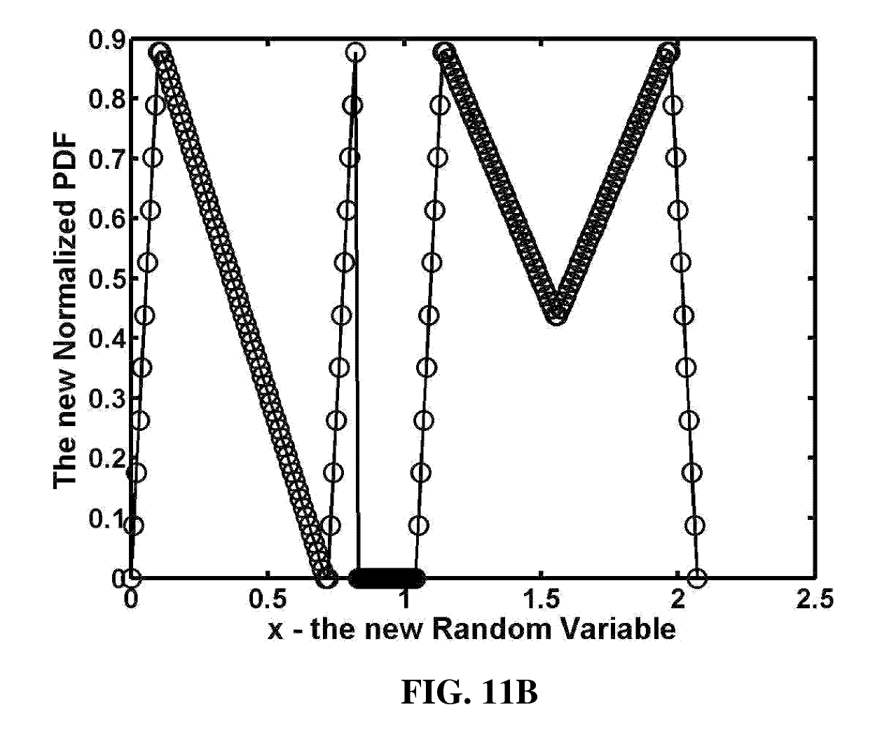

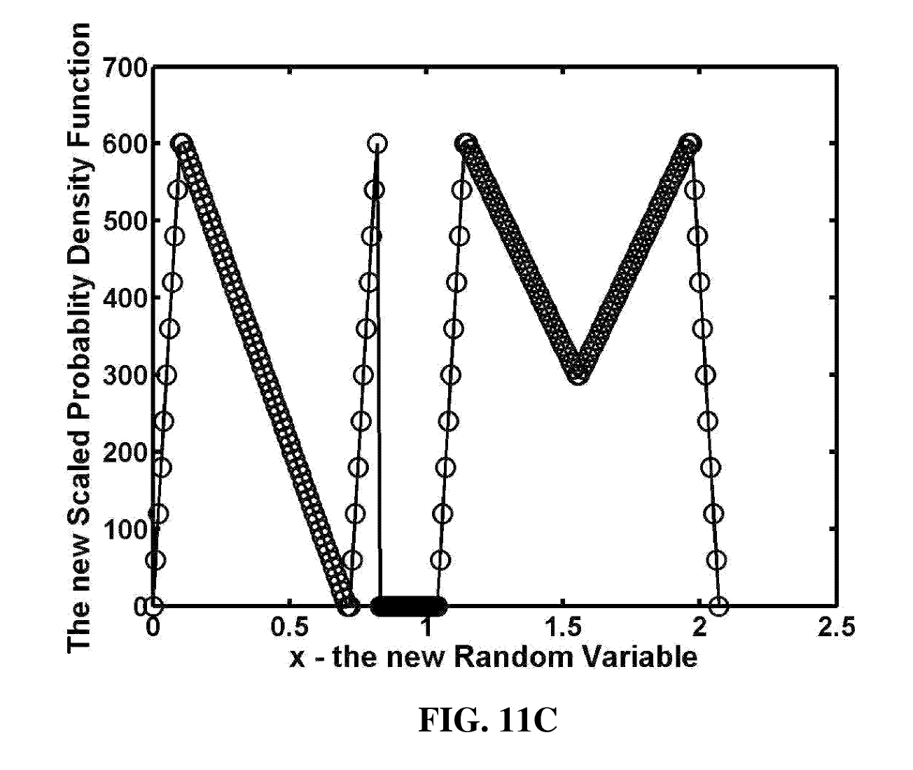

Two numerical examples of certain modes of operation of the method of FIGS. 3A-3D are now provided, including Example A with reference to FIGS. 7A-10 and Example B with reference to FIGS. 11A-13.

### Example A

The arbitrary Probability density function (PDF) is defined as:

$$x = [ \begin{matrix}1 & 2 & 3 & 4 & 5\end{matrix} ] ;$$

$$y = [ \begin{matrix}0.1 & 2 & 0.1 & 2 & 0.1\end{matrix} ] ;$$

as shown in FIG. 7A.

Normalizing, as shown in FIG. 7B, yields:

$${x}^{′} = [ \begin{matrix}1 & 2 & 3 & 4 & 5\end{matrix} ] ;$$

$${y}^{′} = [ \begin{matrix}0.0233 & 0.4651 & 0.0233 & 0.4651 & 0.0233\end{matrix} ] ;$$

Scaling for A=10 and B=100, as shown in FIG. 7C, yields:

$${x}^{″} = [ \begin{matrix}1 & 2 & 3 & 4 & 5\end{matrix} ] ;$$

$${y}^{″} = [ \begin{matrix}10 & 200 & 10 & 200 & 10\end{matrix} ] ;$$

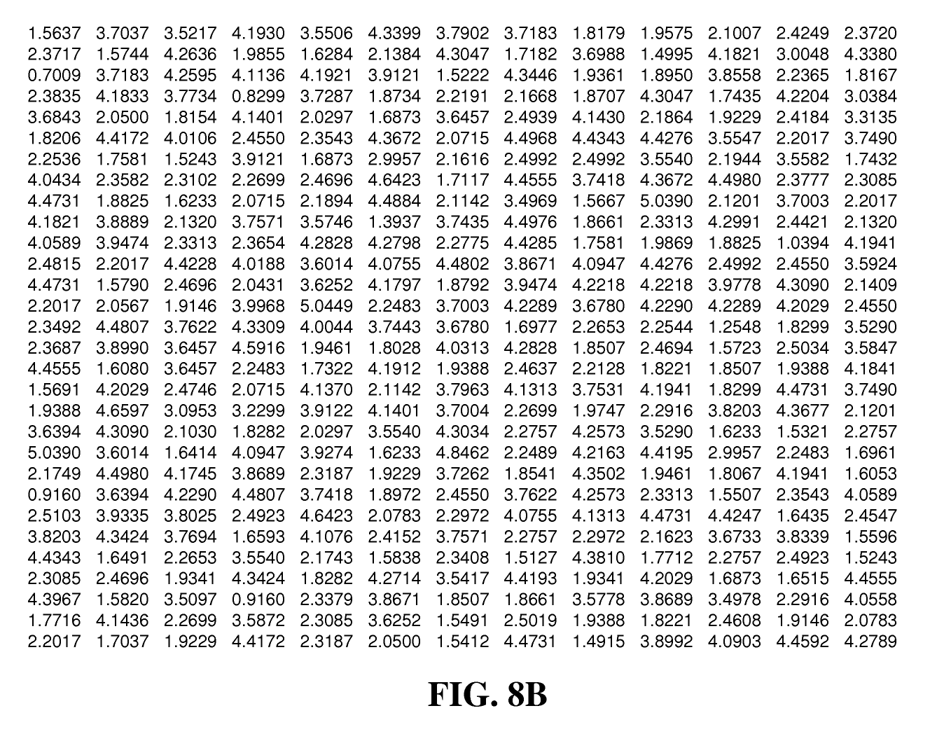

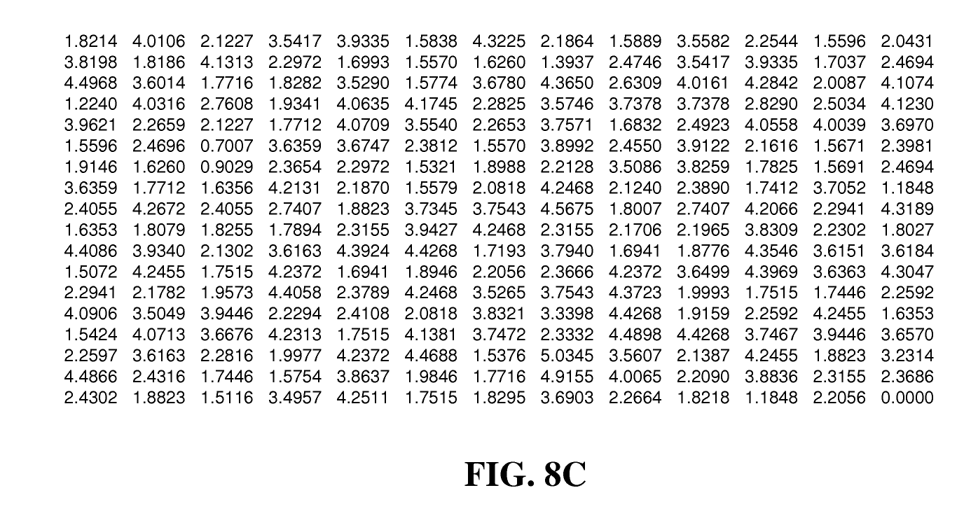

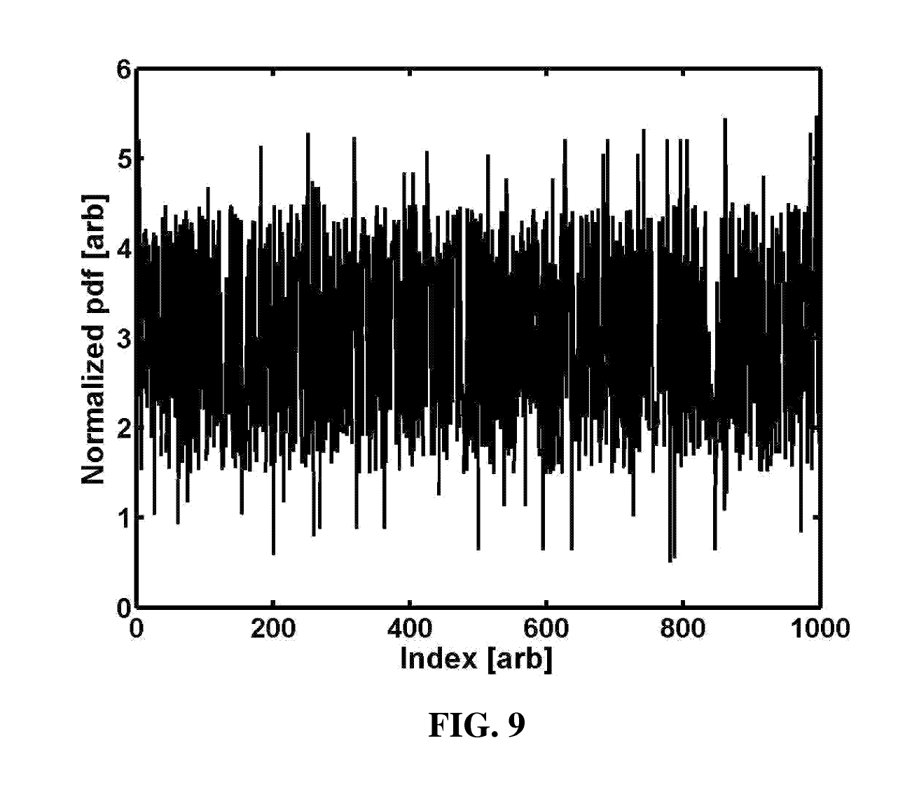

Generating the Random Numbers yields the number stream illustrated in FIGS. 8A-8C, taken together, where the numbers in each row of FIG. 8A are followed by the numbers in the next row, and the rows of FIG. 8A are followed by the rows of FIG. 8B which are then followed by the rows of FIG. 8C. A plot of the number stream is illustrated in FIG. 9.

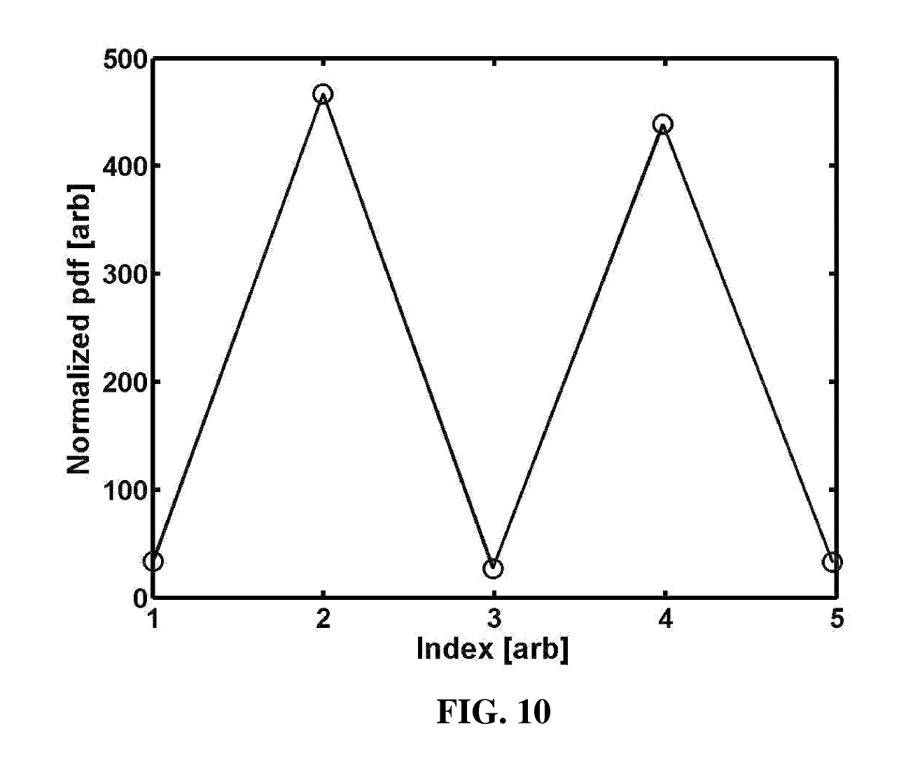

Generating a histogram of the above, as shown in FIG. 10, results in:

$${x}^{′′′} = [ \begin{matrix}1.0378 & 2.0150 & 2.9923 & 3.9695 & 4.9467\end{matrix} ] ;$$

$${y}^{′′′} = [ \begin{matrix}40 & 457 & 22 & 441 & 40\end{matrix} ] ;$$

### Example B

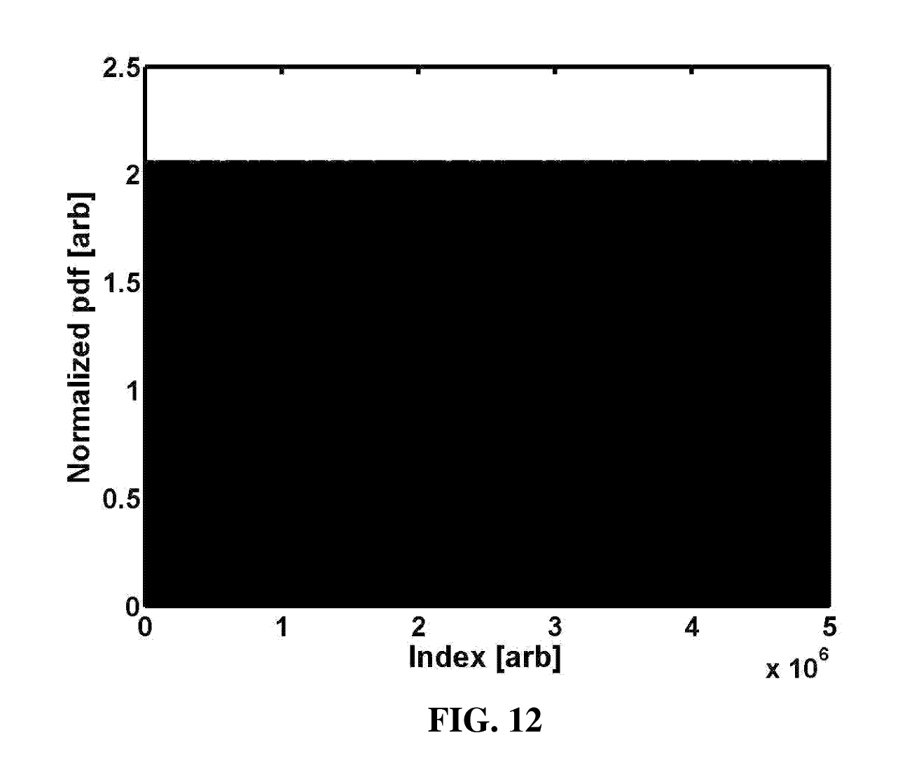

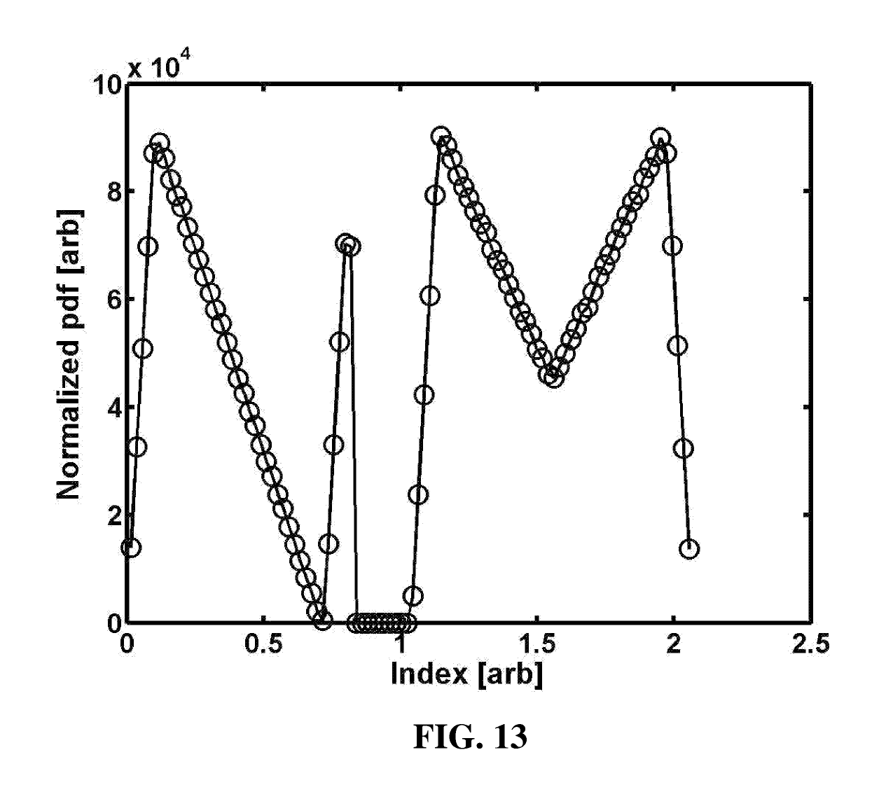

The arbitrary Probability density function (PDF) is defined as that whose shape is of the letters NM, as shown in FIG. 11A. Normalizing yields the normalized PDF shown in FIG. 11B. Scaling for A=10 and B=100 (say) yields the function graphed in FIG. 11C. Generating the Random Numbers as described in FIGS. 3A-3D yields the plot of FIG. 12. Generating a histogram of the above yields the result illustrated in FIG. 13.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

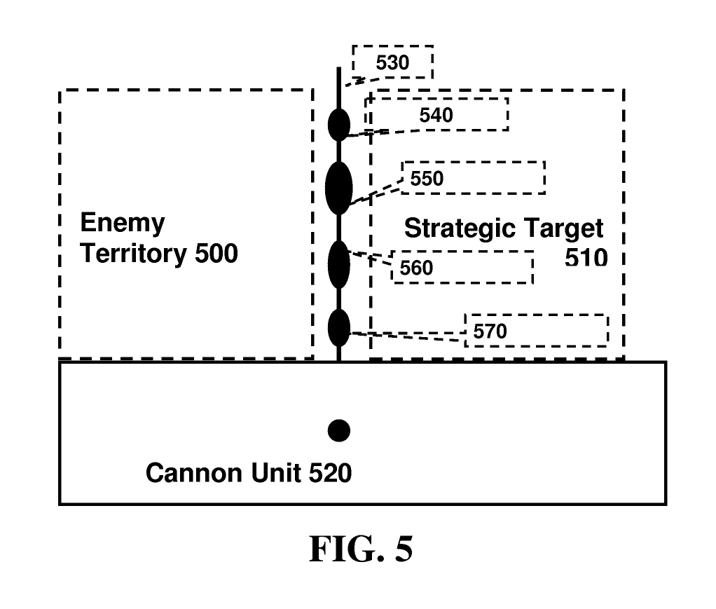

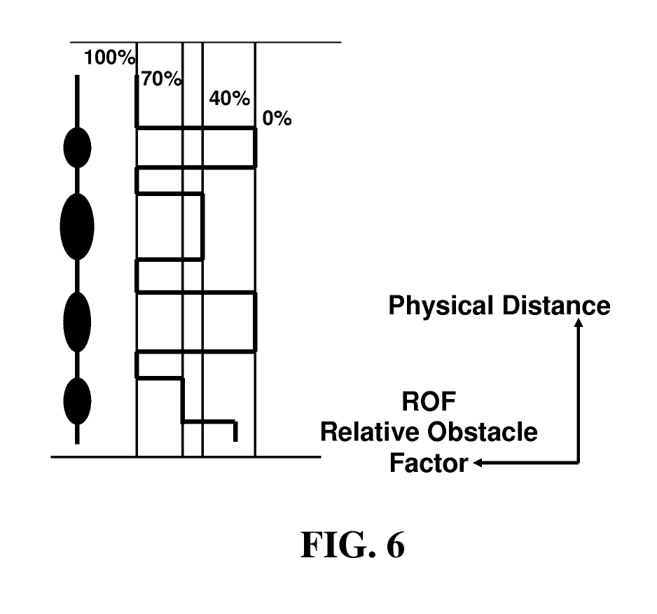

An example application of certain embodiments of the present invention is now described with reference to FIGS. 5-6. Assume that a cannon unit is instructed to defend a narrow band that separates an enemy territory 500 and a strategic target 510, from a cannon unit region 520 which can fire upon a border 530 between the territories 500 and 510. The border 530 includes areas where physical obstacles make it much harder to cross, as well as areas which are easier to pass. For example, border 530 might include obtacles 540, 550, 560 and 570 as shown, whose impenetrability is estimated respectively to be 100, 40, 100 and 70 percent. As a result, it would make sense to bombard areas, where the potential to invade is higher, more heavily than areas where obtacles 540, 550, 560 and 570, and particularly 100% obstacles 540 and 560, are located.

Since it is desirable to conserve ammunition resources, the probability density function graphed in FIG. 6 may be defined as desirable for the cannon unit to achieve.

This PDF may be achieved using the method of, say, FIGS. 3A-3D. The total amount of ammunition available may be defined as N, and then the actual number of bombs can be computed such that the integral of the resulting PDF would equal N.

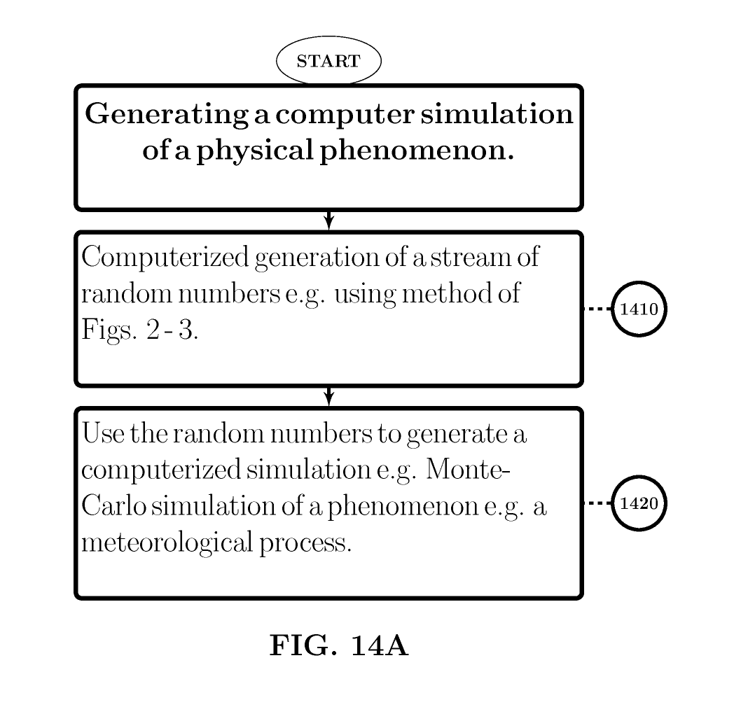

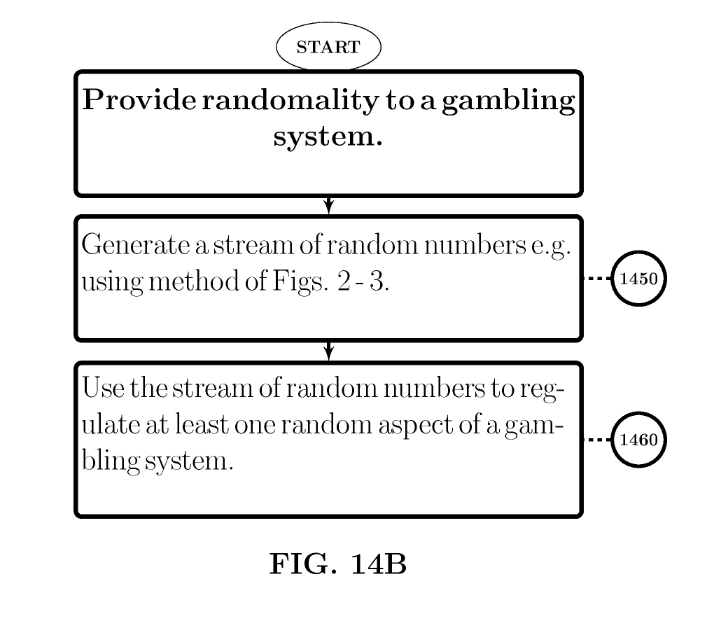

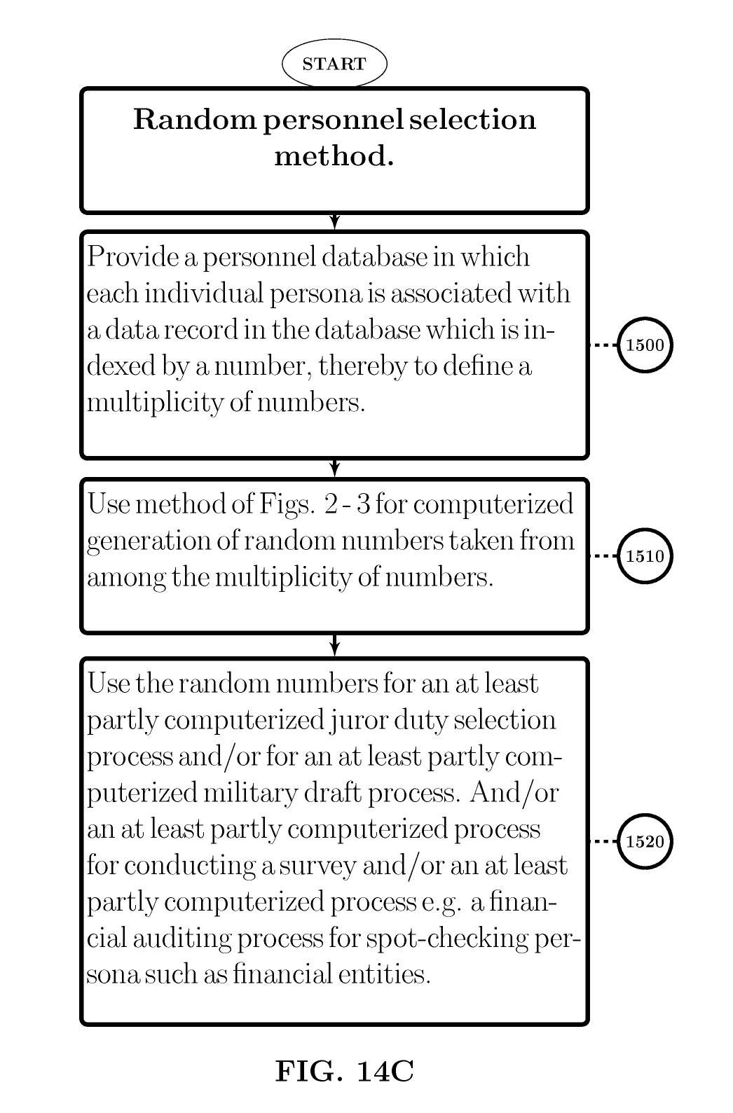

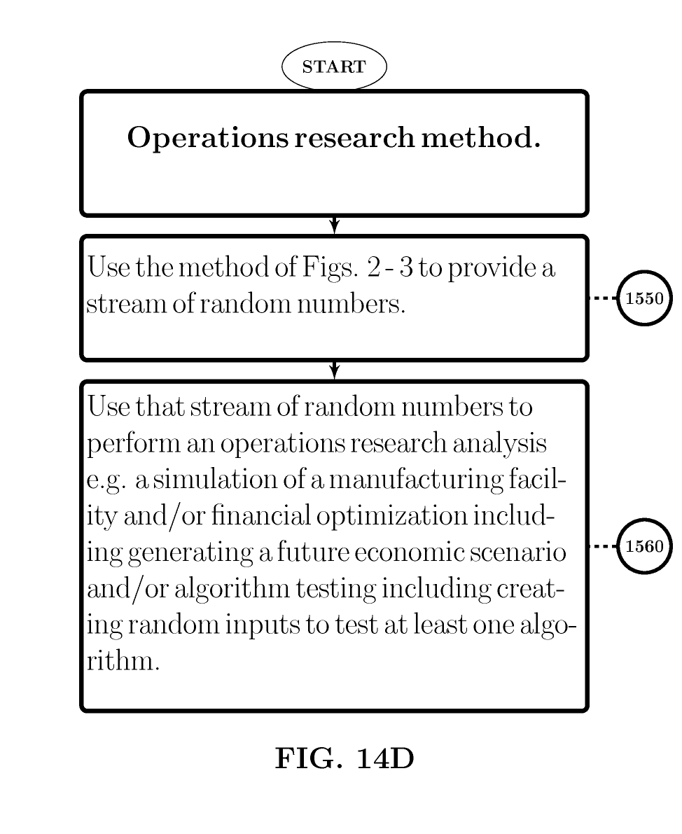

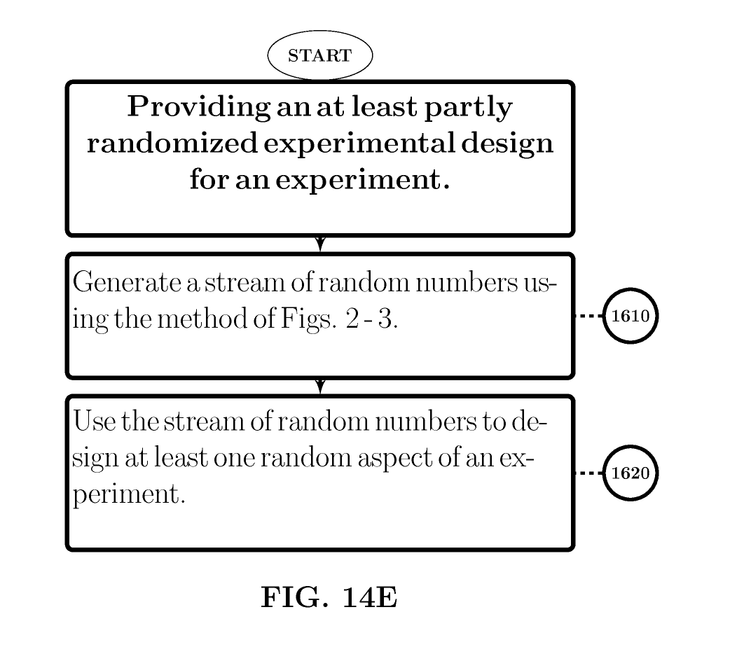

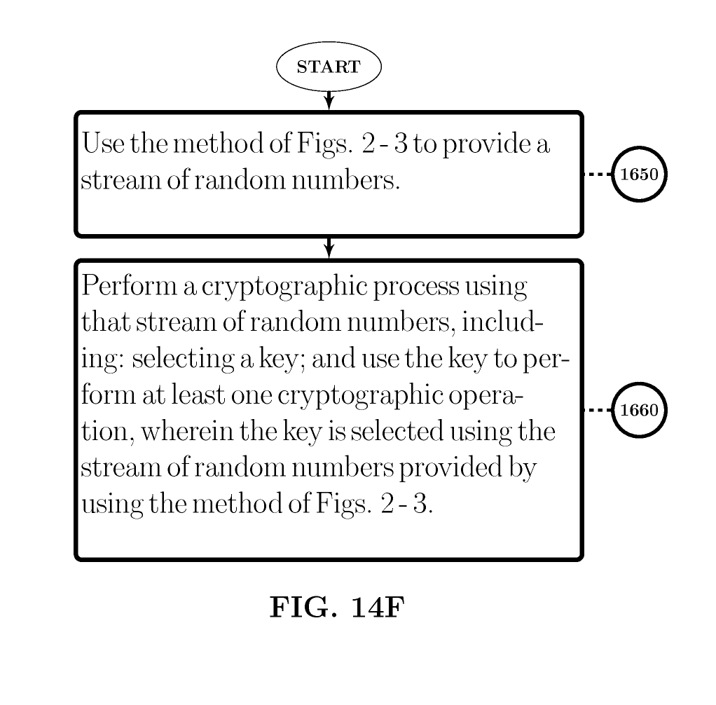

FIGS. 14A-14F are simplified generally self-explanatory flowchart illustrations of various applications for the method of FIGS. 2-3. It is appreciated that the applications particularly shown and illustrated herein are merely exemplary and are not intended to be limiting.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof.

1. A method for generating a stream of random numbers which is representative of a probability distribution function, the method comprising:
receiving a set of K values xᵢ (i=1, . . . K), thereby to define a range within which all of the values fall, and information indicative of the relative probability of each value under the probability distribution function;
for each individual value xᵢ (i=1, . . . K) generating a set of nᵢ numbers uniformly distributed over a vicinity of said individual value xᵢ, where nᵢ is determined, using said information, to reflect the relative probability of said individual value xᵢ, and where the vicinities of xᵢ for all i=1 . . . K partition said range within which all of said values fall; and
providing a stream of numbers by randomly selecting numbers from a set S comprising the union of said sets of nᵢ numbers, for i=1, . . . K.

2. A method according to claim 1 wherein said information comprises a set of K probability values yᵢ wherein each yᵢ represents a relative probability of its corresponding x, under said probability distribution function.

3. A method according to claim 2 wherein said generating includes obtaining a set of all-positive probability values equalling said yᵢ values if all are non-negative.

4. A method according to claim 3 wherein if any of the probability values yᵢ are negative, said obtaining includes translating all of said probability values yᵢ to obtain said set of all-positive probability values by adding a value which is at least as large as the most negative probability value yᵢ, to all of said probability values yᵢ.

5. A method according to claim 3 wherein said generating also includes normalizing said all-positive probability values thereby to generate normalized values y′ᵢ.

6. A method according to claim 5 wherein said normalized values y′ᵢ are computed by setting y′ᵢ=aᵢ yᵢ where aᵢ satisfies: aᵢΣᵢyᵢ/Δx=1.

7. A method according to claim 5 wherein said generating comprises computing a dynamic dᵣ range of the normalized values y′ᵢ.

8. A method according to claim 7 and also comprising finding the smallest normalized value y′min from among said normalized values y′ᵢ and finding a coefficient c which fulfills c y′_min>=dᵣ.

9. A method according to claim 8 and also comprising computing factorized normalized probability values by multiplying each normalized values y′ᵢ by coefficient c.

10. A method according to claim 9 and also comprising rounding the factorized normalized probability values by rounding to obtain a natural number.

11. A method according to claim 10 and also comprising, for each xᵢ and a corresponding one of said factorized normalized probability values, bᵢ, defining an interval around x, and generating a sequence of bᵢ random numbers distributed uniformly within said interval, thereby to obtain a set B of Σᵢ (bᵢ) numbers.

12. A method according to claim 11 wherein intervals defined around adjacent xᵢ values meet at an endpoint which is halfway between said adjacent xᵢ values.

13. A method according to claim 12 wherein said xᵢ values form an arithmetic sequence defining a difference Δx between adjacent members of said sequence and wherein said interval comprises (xᵢ−Δx/2, xᵢ+Δx/2).

14. A method for generating a computer simulation of a physical phenomenon, the method comprising:
computerized generation of a stream of random numbers; and
using said random numbers to generate a computerized simulation of a phenomenon,
wherein said computerized generation includes performing the method of claim 1.

15. A method according to claim 14 wherein said phenomenon comprises a meteorological process.

16. A method for providing randomality to a gambling system, the method comprising:
generating a stream of random numbers using the method of claim 1; and
using said stream of random numbers to regulate at least one random aspect of a gambling system.

17. A random personnel selection method comprising:
providing a personnel database in which each individual persona is associated with a data record in said database which is indexed by a number, thereby to define a multiplicity of numbers; and
using the method of claim 1 for computerized generation of random numbers taken from among said multiplicity of numbers.

18. A method according to claim 17 and also comprising using said random numbers for an at least partly computerized juror duty selection process.

19. A method according to claim 17 and also comprising using said random numbers for an at least partly computerized military draft process.

20. A method according to claim 17 wherein said random numbers are representative of said database and wherein said method also comprises using said random numbers for an at least partly computerized process for conducting a survey.

21. A method according to claim 17 wherein said method also comprises using said random numbers for an at least partly computerized process for spot-checking said persona.

22. A method according to claim 21 wherein said persona comprise financial entities and wherein said at least partly computerized process comprises a financial auditing process.

23. An operations research method comprising:
performing an operations research analysis using a stream of random numbers; and
using the method of claim 1 to provide said stream of random numbers.

24. A method according to claim 23 wherein said operations research analysis comprises a simulation of a manufacturing facility.

25. A method according to claim 23 wherein said operations research analysis comprises financial optimization including generating a future economic scenario.

26. A method according to claim 23 wherein said operations research analysis comprises algorithm testing including creating random inputs to test at least one algorithm.

27. Apparatus for generating a stream of random numbers which is representative of a probability distribution function, the system comprising:
an input device receiving a set of K values xᵢ (i=1, . . . K), thereby to define a range within which all of said values fall, and information indicative of the relative probability of each value under said probability distribution function;
a uniform distribution generator generating, for each individual value xᵢ (i=1, . . . K), a set of nᵢ numbers uniformly distributed over a vicinity of said individual value xᵢ, where nᵢ is determined, using said information, to reflect the relative probability of said individual value xᵢ, and where the vicinities of xᵢ for all i=1 . . . K partition said range within which all of said values fall; and
a number stream generator providing a stream of numbers by randomly selecting numbers from a set S comprising the union of said sets of nᵢ numbers, for i=1, . . . K.

28. A method for providing an at least partly randomized experimental design for an experiment, the method comprising:
generating a stream of random numbers using the method of claim 1; and
using said stream of random numbers to design at least one random aspect of an experiment.

29. A cryptographic method comprising:
performing a cryptographic process using a stream of random numbers; and
using the method of claim 1 to provide said stream of random numbers.

30. A method according to claim 29 wherein said cryptographic process includes:
selecting a key; and
using said key to perform at least one cryptographic operation,
wherein said key is selected using the stream of random numbers provided by using the method of claim 1.

31. A system for generating a computer simulation of a physical phenomenon, the system comprising:
RNG apparatus for computerized generation of a stream of random numbers; and
Simulation apparatus using said random numbers to simulate a phenomenon,
wherein said RNG apparatus includes the apparatus of claim 27.

32. A system according to claim 31 wherein said phenomenon comprises a meteorological process.

33. A system according to claim 31 wherein said simulation apparatus comprises Monte-Carlo simulation apparatus.

34. Cryptographic apparatus comprising:
a key selector operative to select a key using RNG apparatus; and
a cryptographic functionality using said key to perform at least one cryptographic operation,
wherein said RNG apparatus comprises the apparatus of claim 27.

35. A computer program product, comprising a computer usable medium having a computer readable program code embodied therein, said computer readable program code adapted to be executed to implement a method for generating a stream of random numbers which is representative of a probability distribution function, the method comprising:
receiving a set of K values xᵢ (i=1, . . . K), thereby to define a range within which all of the values fall, and information indicative of the relative probability of each value under the probability distribution function;
for each individual value xᵢ (i=1, . . . K) generating a set of nᵢ numbers uniformly distributed over a vicinity of said individual value xᵢ, where nᵢ is determined, using said information, to reflect the relative probability of said individual value xᵢ, and where the vicinities of xᵢ for all i=1 . . . K partition said range within which all of said values fall; and
providing a stream of numbers by randomly selecting numbers from a set S comprising the union of said sets of nᵢ numbers, for i=1, . . . K.
